(19) United States
(12) Patent Application Publication
(10) Pub. No.: US 2023/0186085 A1
(43) Pub. Date: Jun. 15, 2023

(54) LEARNING METHOD, DETERMINING METHOD, LEARNING APPARATUS, DETERMINING APPARATUS, AND NON-TRANSITORY COMPUTER-READABLE STORAGE MEDIUM STORING COMPUTER PROGRAM

(71) Applicant: SEIKO EPSON CORPORATION, Tokyo (JP)

(72) Inventors: Shin NISHIMURA, Shiojiri-shi (JP); Ryoki WATANABE, Matsumoto-shi (JP); Hikaru KURASAWA, Matsumoto-shi (JP)

(21) Appl. No.: 18/063,855

(22) Filed: Dec. 9, 2022

(30) Foreign Application Priority Data
Dec. 10, 2021 (JP) 2021-200573

(51) Int. Cl. G06N 3/08; G06F 18/2431

(52) U.S. Cl. CPC G06N 3/08; G06F 18/2431

(57) ABSTRACT

Provided is a learning method including (a) preparing a plurality of pieces of data for learning; (b) dividing the plurality of pieces of data for learning into one or more groups to generate one or more input learning data groups; and (c) training M number of machine learning models, wherein (b) includes (b1) dividing the plurality of pieces of data for input into one or more regions to generate, as one of the input learning data groups, a collection of first type divided input data after division belonging to the same region, or (b2) dividing the plurality of pieces of data for learning belonging to one class into one or more groups to generate, as one of the input learning data groups, a collection of second type divided input data after division.

The present application is based on, and claims priority from JP Application Serial Number 2021-200573, filed Dec. 10, 2021, the disclosure of which is hereby incorporated by reference herein in its entirety.

### BACKGROUND

### 1. Technical Field

The present disclosure relates to a technique for determining the class of data to be determined using a machine learning model.

### 2. Related Art

In U.S. Pat. No. 5,210,798 and WO 2019/083553, a capsule network is described, the capsule network being a vector neural network type machine learning model using vector neurons. A vector neuron means a neuron with a vector as the input and output. A capsule network is a machine learning model with a vector neuron called a capsule as a node of the network. The vector neural network type machine learning model such as a capsule network can be used to determine the class of input data.

In known technology, when the data amount of the data used in learning and of the data to be determined is large, there may be cases in which the machine learning model learning time and the time taken to input the data to be determined into the machine learning model and determine the class is a long time.

### SUMMARY

According to a first aspect of the present disclosure, a learning method for M number of vector neural network type machine learning models including a plurality of vector neuron layers, the M number of machine learning models being used in determining a class of data to be determined is provided, M being an integer of two or more. The learning method includes (a) preparing a plurality of pieces of data for learning including data for input and a pre-label associated with the data for input, (b) dividing the plurality of pieces of data for learning into one or more groups to generate one or more input learning data groups, and (c) training the M number of machine learning models so that a correspondence between the data for input and the pre-label associated with the data for input is reproduced, by inputting the corresponding input learning data groups respectively into the M number of machine learning models, wherein (b) includes (b1) dividing the plurality of pieces of data for input into one or more regions to generate, as one of the input learning data groups, a collection of first type divided input data after division belonging to the same region, or (b2) dividing the plurality of pieces of data for learning belonging to one class into one or more groups to generate, as one of the input learning data groups, a collection of second type divided input data after division.

According to a second aspect of the present disclosure, a determining method for determining a class of data to be determined using M number of vector neural network type machine learning models including a plurality of vector neuron layers is provided, M being an integer of two or more. The determining method includes (a) preparing the M number of machine learning models trained using a plurality of pieces of data for learning including data for input and a pre-label associated with the data for input, wherein each one of the M number of machine learning models is trained using one corresponding group of one or more input learning data groups, the one or more input learning data groups being obtained by dividing the plurality of pieces of data for learning, (b) preparing M number of known feature spectrum groups corresponding to the M number of machine learning models after training, wherein the M number of known feature spectrum groups include a known feature spectrum group obtained from an output of a specific layer from among the plurality of vector neuron layers by inputting the input learning data groups into the M number of machine learning models after the training, (c) obtaining individual data used in class determination of the data to be determined for each one of the M number of machine learning models by inputting data to be determined for input generated from the data to be determined into each one of the M number of machine learning models after the training, wherein, for each one of the M number of machine learning models, the individual data is generated using at least one of (i) a similarity between a feature spectrum calculated from an output of the specific layer according to input of the data to be determined for input into the machine learning model and the known feature spectrum group, and (ii) an activation value corresponding to a determination value for each class output from an output layer of the machine learning model according to an input of the data to be determined for input, and (d) executing class determination for the data to be determined using M number of pieces of the individual data obtained respectively for the M number of machine learning models, wherein (a) includes one of (a1) dividing the plurality of pieces of data for input into one or more regions, and using a collection of first type divided input data after division belonging to the same region as one of the input learning data groups, and (a2) executing division processing to divide the plurality of pieces of data for learning belonging to one class into one or more groups, and using a collection of second type divided input data after the division processing as one of the input learning data groups.

According to a third aspect of the present disclosure, a learning apparatus for M number of vector neural network type machine learning models including a plurality of vector neuron layers, the M number of machine learning models being used in determining a class of data to be determined is provided, M being an integer of two or more. The learning apparatus includes a memory, and a processor configured to execute training of the M number of machine learning models, wherein the processor executes processing to divide a plurality of pieces of data for learning including data for input and a pre-label associated with the data for input into one or more groups to generate the one or more input learning data groups, and processing to train the M number of machine learning models so that a correspondence between the data for input and the pre-label associated with the data for input is reproduced by inputting the corresponding input learning data groups respectively into the M number of machine learning models, the processing to generate the one or more input learning data groups includes

processing to divide the plurality of pieces of data for input into one or more regions and generate, as one of the input learning data groups, a collection of first type divided input data after division belonging to the same region, or processing to divide the plurality of pieces of data for learning belonging to one class into one or more groups to generate, as one of the input learning data groups, a collection of second type divided input data after division.

According to a fourth aspect of the present disclosure, a determining apparatus for determining a class of data to be determined using M number of vector neural network type machine learning models including a plurality of vector neuron layers is provided, M being an integer of two or more. The determining apparatus includes a memory configured to store the M number of machine learning models trained using a plurality of pieces of data for learning including data for input and a pre-label associated with the data for input, wherein each one of the M number of machine learning models is trained using one corresponding group of one or more input learning data groups, the one or more input learning data groups being obtained by dividing the plurality of pieces of data for learning, and

a processor configured to execute class determination of the data to be determined by inputting the data to be determined into the M number of machine learning models, wherein the processor executes processing to generate M number of known feature spectrum groups corresponding to the M number of machine learning models after training, wherein the M number of known feature spectrum groups include a known feature spectrum group obtained from an output of a specific layer from among the plurality of vector neuron layers by inputting the input learning data groups into the M number of machine learning models after the training, processing to obtain individual data used in class determination of the data to be determined for each one of the M number of machine learning models by inputting data to be determined for input generated from the data to be determined into each one of the M number of machine learning models after the training, wherein, for each one of the M number of machine learning models, the individual data is generated using at least one of (i) a similarity between a feature spectrum calculated from an output of the specific layer according to input of the data to be determined for input into the machine learning model and the known feature spectrum group, and (ii) an activation value corresponding to a determination value for each class output from an output layer of the machine learning model according to an input of the data to be determined for input, and processing to execute class determination for the data to be determined using M number of pieces of the individual data obtained respectively for the M number of machine learning models, and the input learning data group is either

a collection of first type divided input data after division belonging to the same region of one or more regions obtained by dividing the plurality of pieces of data for input, or a collection of second type divided input data after the division processing in which the plurality of pieces of data for learning belonging to one class are divided into one or more groups.

According to a fifth aspect of the present disclosure, a non-transitory computer-readable storage medium storing a computer program configured to cause a processor to execute training of M number of vector neural network type machine learning models including a plurality of vector neuron layers, the M number of machine learning models being used in determining a class of data to be determined is provided, M being an integer of two or more. The computer program includes a function (a) of dividing a plurality of pieces of data for learning including data for input and a pre-label associated with the data for input into one or more groups to generate the one or more input learning data groups, and a function (b) of training the M number of machine learning models so that a correspondence between the data for input and the pre-label associated with the data for input is reproduced by inputting the corresponding input learning data groups respectively into the M number of machine learning models, wherein the function (a) includes

a function of dividing the plurality of pieces of data for input into one or more regions to generate, as one of the input learning data groups, a collection of first type divided input data after division belonging to the same region, or a function of dividing the plurality of pieces of data for learning belonging to one class into one or more groups to generate, as one of the input learning data groups, a collection of second type divided input data after division.

According to a sixth aspect of the present disclosure, a non-transitory computer-readable storage medium storing a computer program configured to cause a processor to execute determination of a class of data to be determined using M number of vector neural network type machine learning models including a plurality of vector neuron layers is provided, M being an integer of two or more. The computer program includes a function (a) of storing the M number of machine learning models trained using a plurality of pieces of data for learning including data for input and a pre-label associated with the data for input, wherein each one of the M number of machine learning models is trained using one corresponding group of one or more input learning data groups, the one or more input learning data groups being obtained by dividing the plurality of pieces of data for learning, a function (b) of generating M number of known feature spectrum groups corresponding to the M number of machine learning models after training, wherein the M number of known feature spectrum groups include a known feature spectrum group obtained from an output of a specific layer from among the plurality of vector neuron layers by inputting the input learning data groups into the M number of machine learning models after the training, a function (c) of obtaining individual data used in class determination of the data to be determined for each one of the M number of machine learning models by inputting data to be determined for input generated from the data to be determined into each one of the M number of machine learning models after the training, wherein, for each one of the M number of machine learning models, the individual data is generated using at least one of (i) a similarity between a feature spectrum calculated from an output of the specific layer according to input of the data to be determined for input into the machine learning model and the known feature spectrum group, and (ii) an activation value corresponding to a determination value for each class output from an output layer of the machine learning model according to an input of the data to be determined for input, and a function (d) of executing class determination for the data to be determined using M number of pieces of the individual data obtained respectively for the M number of machine learning models, wherein the input learning data group is either a collection of first type divided input data after division belonging to the same region of one or more regions obtained by dividing the plurality of pieces of data for input, or a collection of second type divided input data after the division processing in which the plurality of pieces of data for learning belonging to one class are divided into one or more groups.

### BRIEF DESCRIPTION OF THE DRAWINGS

FIG. 1 is a explanatory diagram illustrating a class determination system according to a first embodiment.

FIG. 2 is a block diagram illustrating functions of a determining apparatus.

FIG. 3 is an explanatory diagram illustrating a configuration of a machine learning model.

FIG. 4 is an explanatory diagram illustrating another configuration of a machine learning model.

FIG. 5 is a flowchart illustrating the learning process of M number of machine learning models.

FIG. 6 is a diagram illustrating first data processing.

FIG. 7 is a diagram illustrating input learning data.

FIG. 8 is a flowchart illustrating a pre-preparation process of preparing a known feature spectrum group.

FIG. 9 is an explanatory diagram illustrating a feature spectrum.

FIG. 10 is an explanatory diagram illustrating how the known feature spectrum group is generated.

FIG. 11 is an explanatory diagram illustrating a configuration of the known feature spectrum group.

FIG. 12 is a flowchart illustrating a class determination process for the data to be determined.

FIG. 13 is a detailed flowchart of step S36 of FIG. 12.

FIG. 14 is a first drawing for describing the class determination process.

FIG. 15 is a second drawing for describing the class determination process.

FIG. 16 is a diagram for describing another embodiment 1 of the class determination process.

FIG. 17 is a diagram for describing another embodiment 2 of the class determination process.

FIG. 18 is a diagram for describing another embodiment 3 of the class determination process.

FIG. 19 is a diagram for describing another embodiment of a pre-determined class generation process.

FIG. 20 is a diagram for describing another embodiment of the first embodiment.

FIG. 21 is a flowchart illustrating a learning process according to a second embodiment.

FIG. 22 is a conceptual diagram of clustering.

FIG. 23 is a diagram for describing step S2a12a.

FIG. 24 is an explanatory diagram illustrating a first calculation method M1 for by class similarity.

FIG. 25 is an explanatory diagram illustrating a second calculation method M2 for by class similarity.

FIG. 26 is an explanatory diagram illustrating a third calculation method M3 for by class similarity.

### DESCRIPTION OF EXEMPLARY EMBODIMENTS

### A. First Embodiment

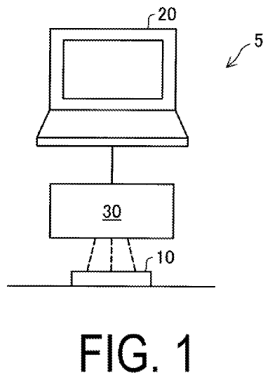

FIG. 1 is a block diagram illustrating a determination system according to the first embodiment. A determination system 5 includes a determining apparatus 20 and a spectrometer 30. The spectrometer 30 is capable of performing spectroscopic measurement on a target object 10 and acquiring a spectral reflectance. In the present disclosure, the spectral reflectance is also referred to as “spectral data”. The spectrometer 30 includes, for example, a wavelength variable interference spectroscopic filter and a monochrome image sensor. The spectral data obtained by the spectrometer 30 is used as data to be determined, which is input into a machine learning model described below. The determining apparatus 20 executes class determination processing on the spectral data using the machine learning model and determines which one of a plurality of classes the target object 10 corresponds to. The expression “the class of the target object 10” means the type of the target object 10. The determining apparatus 20 may output the determined type of the target object 10 to a display unit, i.e., an output unit. In this manner, the user can easily come to know the type of the target object 10. Note that the determination system according to the present disclosure can be implemented as a different system and may be implemented as a system that executes class determination that uses an image to be determined, one-dimensional data other than spectral data, a spectral image, time series data, and the like as the data to be determined.

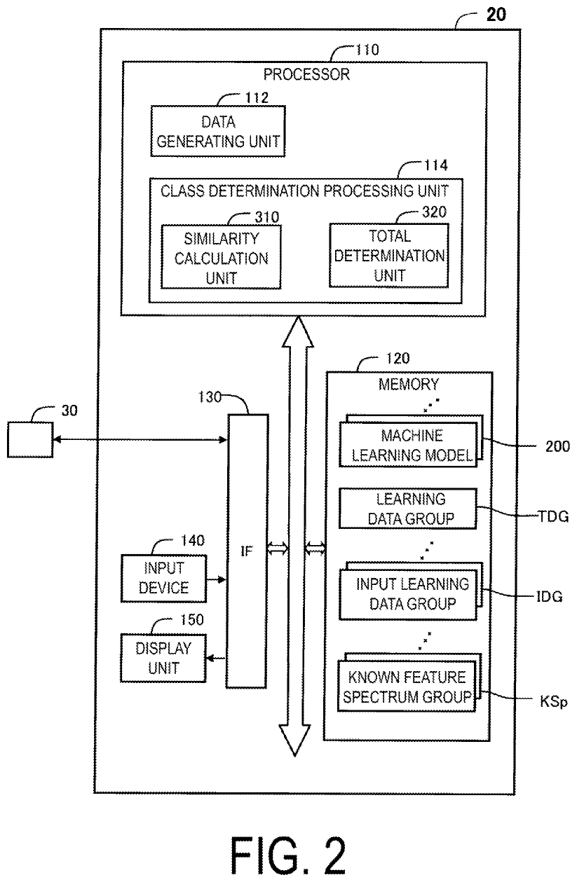

FIG. 2 is a block diagram illustrating functions of the determining apparatus 20. The determining apparatus 20 includes a processor 110, a memory 120, an interface circuit 130, and an input device 140 and a display unit 150 connected to the interface circuit 130. The determining apparatus 20 is, for example, a personal computer. The spectrometer 30 is also connected to the interface circuit 130. Although not limited, for example, the processor 110 has not only a function of executing processing described in detail below, but also a function of displaying data obtained by the processing and data generated in the process of the processing on the display unit 150.

The processor 110 functions as a data generating unit 112 that generates data to be input into a machine learning model 200 from pieces of data of an input learning data group IDG used in training the machine learning model 200 and from data for input IM such as data to be determined IM and the like and functions as a class determination processing unit 114 that executes class determination processing of the data to be determined IM. The data generating unit 112 and the class determination processing unit 114 are implemented by the processor 110 executing the computer program stored in the memory 120.

The data generating unit 112 executes one of the following two types of data processing to generate the input learning data group IDG.

(1) First Data Processing:

Each one of the plurality of data for input IM is divided into M or more number of regions, and a collection of first type divided input data IDa after division that belongs in the same region is generated as one input learning data group IDG.

(2) Second Data Processing:

Division processing is executed to divide the plurality of data for input IM belonging to one class into M or more number of pieces, and a collection of second type divided input data IDb after division is generated as one input learning data group IDG.

The class determination processing unit 114 includes a similarity calculation unit 310 and a total determination unit 320. The class determination processing unit 114 inputs the data to be determined IM into M number of machine learning models 200 and uses a plurality of individual data DD obtained for each one of the M number of machine learning models 200 to determine the class of the data to be determined IM. The details will be described below. Note that the data input into the machine learning model 200 is denoted by the reference sign IM regardless of the type of data.

In the foregoing, at least one of the functions of the data generating unit 112 and the class determination processing unit 114 may be implemented by a hardware circuit. In the present specification, the term processor includes such a hardware circuit. The processor for executing the class determination processing may be a processor included in a remote computer connected to the determining apparatus 20 via a network.

The memory 120 stores the plurality of machine learning models 200, a learning data group TDG, the plurality of input learning data groups IDG, and a plurality of known feature spectrum groups KSp. The machine learning model 200 is used in the processing by the class determination processing unit 114. Each one of the plurality of machine learning models 200 is a vector neural network type machine learning model including a plurality of vector neuron layers. An example configuration and operation of the machine learning model 200 will be described below. The number of machine learning models 200 is represented by M, and M can be set to any integer greater than or equal to 2. In the present embodiment, a case in which five machine learning models 200 are used is described. Note that when the five machine learning models 200 are referred to separately, the suffix “_T (T is an integer from 1 to 5)” is attached at the end. That is, the five machine learning models 200 are machine learning models 200_1 to 200_5. Note that, for the five machine learning models 200, also referred to as the first model 200_1, the second model 200_2, the third model 200_3, the fourth model 200_4, and the fifth model 200_5.

The learning data group TDG is a collection of data for learning TD which is training data. In the present embodiment, each piece of data for learning TD of the learning data group TDG includes spectral data as data for input and a pre-label LB associated with the spectral data. In the present embodiment, the pre-label LB is a label indicating the type of the target object 10. Note that in the present embodiment, “label” and “class” have the same meaning. The input learning data group IDG is a data group generated by the data generating unit 112 using the learning data group TDG. M or more number of input learning data groups IDG are generated. The input learning data groups IDG are generated by dividing the plurality of data for learning TD composing the learning data group TDG into M or more number of pieces. Note that in the present embodiment, the number of the input learning data groups IDG is M, the same as the number of the machine learning models 200. Note that when the five input learning data groups IDG are referred to separately, the suffix “_T (T is an integer from 1 to 5)” is attached at the end. That is, the five input learning data groups IDG are input learning data groups IDG_1 to IDG_5.

The known feature spectrum group KSp is a collection of feature spectra obtained when the learning data group TDG is input into the trained machine learning model 200. The feature spectra are described below. The learning data groups TDG and the known feature spectrum groups KSp supported by each machine learning model 200 are used in the machine learning models 200.

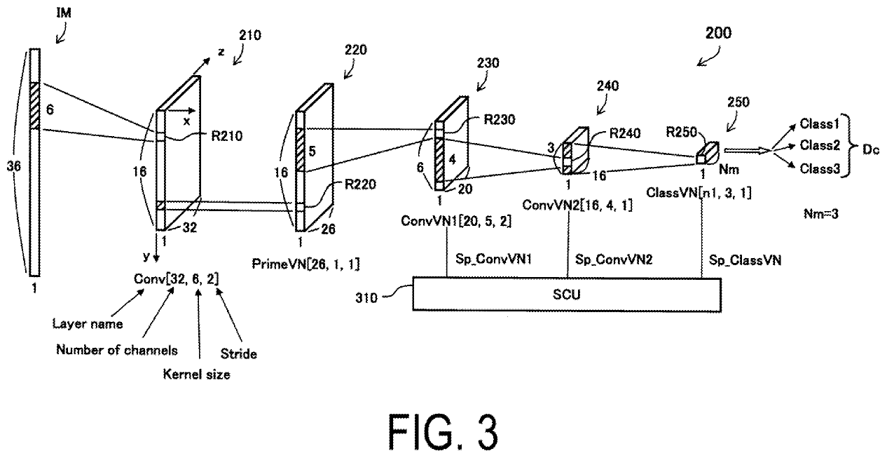

FIG. 3 is an explanatory diagram illustrating the configuration of the machine learning model 200. The machine learning model 200 includes, in order from the data for input IM side, a convolutional layer 210, a primary vector neuron layer 220, a first convolutional vector neuron layer 230, a second convolutional vector neuron layer 240, and a classification vector neuron layer 250 which is an output layer. Of these five layers 210 to 250, the convolutional layer 210 is the lowest layer and the classification vector neuron layer 250 is the uppermost layer. In the following description, the layers 210 to 250 are also referred to as a “Cony layer 210”, a “PrimeVN layer 220”, a “ConvVN1 layer 230”, a “ConvVN2 layer 240”, and a “ClassVN layer 250”, respectively.

In the present embodiment, the data for input IM to be input is spectral data and thus is data of a one-dimensional array. For example, the data IM to be input is data obtained by extracting 36 representative values every 10 nm from the spectral data in a range of from 380 nm to 730 nm.

In the example of FIG. 3, two convolutional vector neuron layers 230 and 240 are used, but the number of convolutional vector neuron layers is discretionary, and the convolutional vector neuron layer may be omitted. However, one or more convolutional vector neuron layers is preferably used.

The configuration of each layer 210 to 250 in FIG. 3 can be described as follows.

Description of Configuration of Machine Learning Model 200

Cony layer 210: Conv [32, 6, 2]

PrimeVN layer 220: PrimeVN [26, 1, 1]

ConvVN1 layer 230: ConvVN1 [20, 5, 2]

ConvVN2 layer 240: ConvVN2 [16, 4, 1]

ClassVN layer 250: Class VN [Nm, 3, 1]

Vector dimension VD: VD=16

In the description of these layers 210 to 250, the character string before parentheses is a layer name, and numbers inside the parentheses are the number of channels, the surface size of a kernel, and the stride in this order. For example, for the Conv layer 210, the layer name is “Conv”, the number of channels is 32, the surface size of a kernel is _1×6, and the stride is 2. In FIG. 3, these descriptions are listed below each layer. The hatched rectangle drawn in each layer represents the surface size of a kernel used when an output vector of an adjacent upper layer is calculated. In the present embodiment, because the data for input IM is one-dimensional array data, the surface size of a kernel is also one dimension. Note that the values of the parameters used in the description of each of the layers 210 to 250 are examples and can be discretionarily changed.

The Conv layer 210 is a layer composed of scalar neurons. The other four layers 220 to 250 are layers composed of vector neurons. A vector neuron is a neuron with a vector for the input and output. In the above description, the dimension of the output vector of each vector neuron is constant at 16. In the following description, the term “node” is used as an upper concept of the scalar neuron and the vector neuron.

In FIG. 3, a first axis x and a second axis y that define plane coordinates of a node array and a third axis z that represents depth are indicated for the Conv layer 210. In addition, 1, 16, and 32 for the size in x, y, and z directions are indicated for the Conv layer 210. The size in the x direction and the size in the y direction are called “resolution”. In the present embodiment, the resolution in the x direction is always 1.The size in the z direction is the number of channels. These three axes x, y, and z are also used as coordinate axes indicating positions of the nodes in other layers. However, in FIG. 3, the axes x, y, and z are not illustrated in layers other than for the Conv layer 210.

As is well known, a resolution W1 in the y direction after convolution is given by the following equation.

W1=Ceil{(W0−Wk+1)/S} (1)

Here, W0 is the resolution before convolution, Wk is the surface size of the kernel, S is the stride, and Ceil{X} is a function for performing an operation of rounding up X.

The resolution of each layer illustrated in FIG. 3 is an example of when the resolution of the data for input IM in the y direction is 36, and the actual resolution of each layer is appropriately changed according to the size of the data for input IM.

The ClassVN layer 250 has Nm number of channels. In the example of FIG. 3, Nm=3. In general, Nm is an integer of 2 or more and is the number of known classes that can be determined using the machine learning model 200. The number of classes Nm that can be determined can be set to a different value for each machine learning model 200. The total number of classes that can be determined in M number of machine learning models 200 is represented by ΣNm. Determination values Class 1 to Class 3 for the three known classes are output from the three channels of the ClassVN layer 250. Usually, a class having the largest value among the determination values Class 1 to Class 3 is used as the class determination result for the data IM. On the other hand, in the present embodiment, a determination value C output for each one of the five machine learning models 200 composes one element of the individual data DD. Also, the total determination unit 320 executes class determination of the data to be determined IM using the individual data DD of each machine learning model 200. The details will be described below. The determination values Class 1 to Class 3 are also referred to as activation values a.

In FIG. 3, a partial region Rn in each one of the layers 210, 220, 230, 240, and 250 is further illustrated. The suffix “n” of the partial region Rn is a reference sign of each layer. For example, the partial region R210 indicates the partial region in the Conv layer 210. The “partial region Rn” is a region that is specified by a plane position (x, y) defined by a position of the first axis x and a position of the second axis y in each layer and includes a plurality of channels along the third axis z. The partial region Rn has dimensions of “Width” x “Height” x “Depth” corresponding to the first axis x, the second axis y, and the third axis z. In the present embodiment, the number of nodes included in one “partial region Rn” is “1×1×depth”, that is, “1×1×number of channels”.

As illustrated in FIG. 3, a feature spectrum Sp_ConvVN1 described below is calculated from the output of the ConvVN1 layer 230 and is input to the similarity calculation unit 310. Similarly, feature spectrum Sp_ConvVN2 and Sp_ClassVN are calculated from the outputs of the ConvVN2 layer 240 and the ClassVN layer 250, respectively and input to the similarity calculation unit 310. The similarity calculation unit 310 calculates class similarities Sclass, which will be described later, by using the feature spectrum Sp_ConvVN1, Sp_ConvVN, and Sp_ClassVN and the known feature spectrum group KSp that is generated in advance.

In the present disclosure, the vector neuron layer used for calculation of a similarity is also referred to as a “specific layer”. As the specific layer, a discretionary number of one or more vector neuron layers can be used. Note that the configuration of the feature spectrum Sp and the calculation method of a similarity S using the feature spectrum Sp are described below.

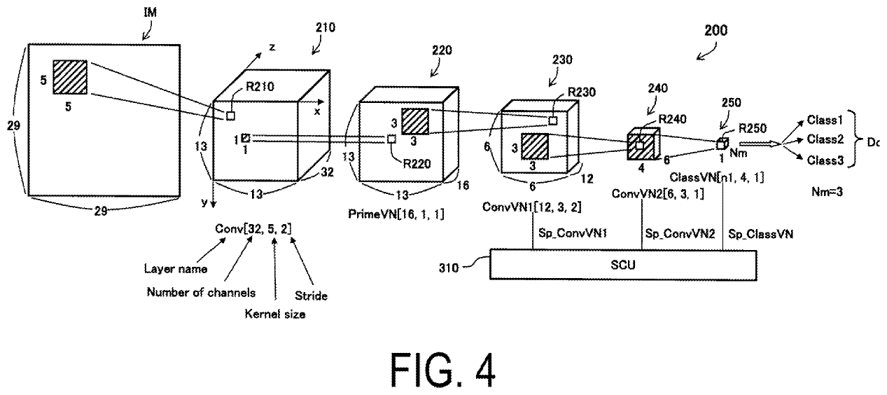

FIG. 4 is an explanatory diagram illustrating another configuration of the machine learning model 200. The machine learning model 200 is different from the machine learning model 200 in FIG. 3 that uses one-dimensional array data in that the data for input IM to be input is two-dimensional array data. The configuration of each layer 210 to 250 in FIG. 4 can be described as follows.

Description of Configuration of Each Layer

Cony layer 210: Conv [32, 5, 2]

PrimeVN layer 220: PrimeVN [16, 1, 1]

ConvVN1 layer 230: ConvVN1 [12, 3, 2]

ConvVN2 layer 240: ConvVN2 [6, 3, 1]

ClassVN layer 250: Class VN [Nm, 4, 1]

Vector dimension VD: VD=16

The machine learning model 200 illustrated in FIG. 4 can be used, for example, in a determination system that executes class determination on an image to be determined. However, in the following description, the machine learning model 200 illustrated in FIG. 3 is used.

When the data to be determined IM is input into the five machine learning model 200, the feature spectrum Sp is calculated from the specific layer of each one of the five machine learning models 200 and these are input into the similarity calculation unit 310. The similarity calculation unit 310 calculates a by class similarity Sclass, which is the similarity between the feature spectrum Sp and the known feature spectrum groups KSp of a corresponding specific layer.

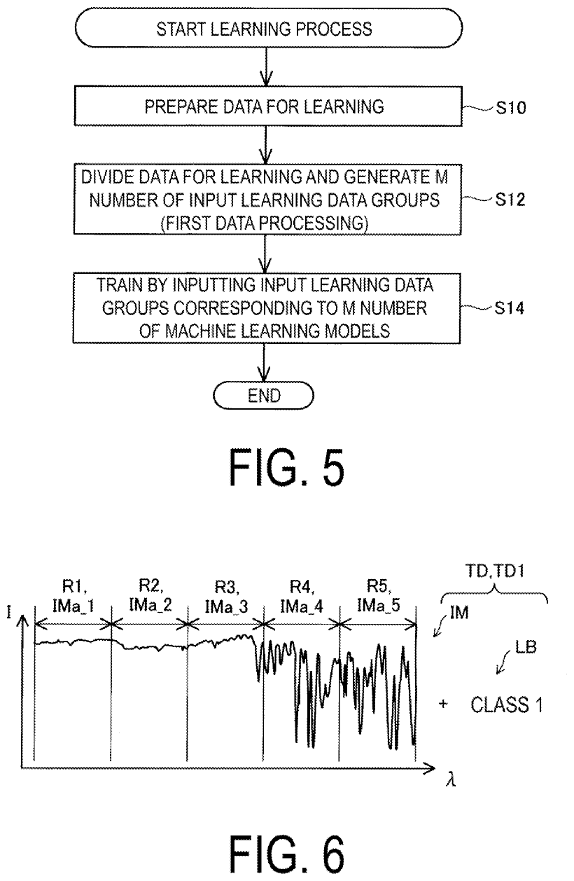

FIG. 5 is a flowchart illustrating the learning process of M number of machine learning models 200. In step S10, the plurality of data for learning TD including spectral data, which is data for input IM, and the pre-label LB associated with the data for input IM is prepared. In other words, the spectrometer 30 performs a spectroscopic measurement on the target object 10 with the class to be sorted into by type being known in advance to acquire the spectral data, and this spectral data corresponds to the data for input IM. Furthermore, the pre-label LB corresponding to the type known in advance is associated with the data for input IM, and thus the data for learning TD is generated.

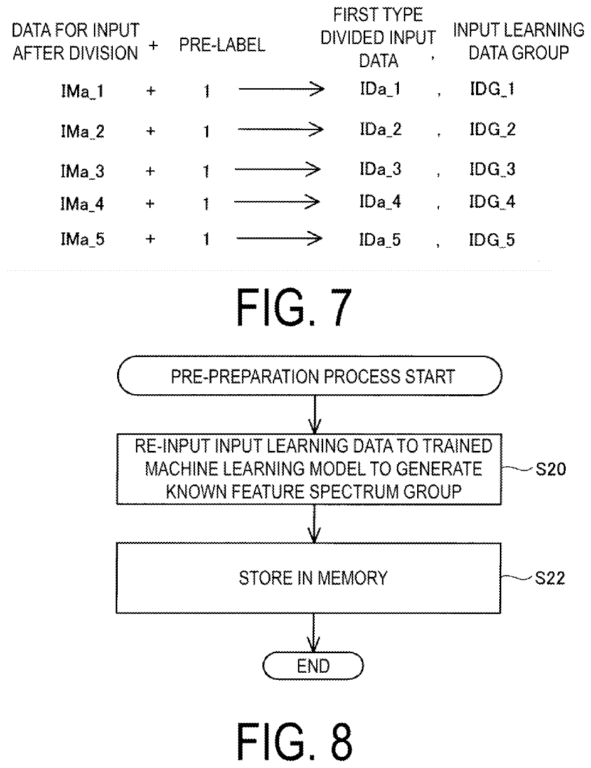

In step S12, the data generating unit 112 executes the first data processing. Specifically, the data generating unit 112 divides the plurality of data for learning TD prepared in step S10 and generates M number of input learning data groups IDG. An example of step S12 executed by the data generating unit 112 via the first data processing will be described using FIGS. 6 and 7.

FIG. 6 is a diagram illustrating the first data processing. FIG. 7 is a diagram illustrating input learning data ID. The data generating unit 112 divides a single piece of data for input IM into five regions R1 to R5 to obtain data for input IMa_1 to IMa_5 after division corresponding to the regions R1 to R5. The five regions R1 to R5 may be configured without overlap, or some elements of adjacent regions R1 to R5 may overlap. In the present embodiment, the data generating unit 112 equally divides the wavelength range so that the wavelength λ is a uniform length in the range of from 380 nm to 730 nm. As illustrated in FIG. 7, first type divided input data IDa_1 to IDa_5 is obtained by associating the data for input IMa_1 to IMa_5 after division with the pre-label LB associated with the data for input IM, which is the division source. Note that when the data for input IMa_1 to IMa_5 after division is referred to without distinction, the term data for input IMa after division is used. Note that when the first type divided input data IDa_1 to IDa_5 is referred to without distinction, the term first type divided input data IDa is used.

The data generating unit 112 executes the division of a single piece of data for input IM for each data for input IM to generate the input learning data group IDG, which is a collection of the first type divided input data IDa belonging to the same region.

As illustrated in FIG. 5, in step S14 after step 5112, the processor 110 trains the M number of machine learning models 200_1 to 200_5 by inputting into the M number of machine learning models 200_1 to 200_5 the corresponding input learning data groups IDG_1 to IDG_5. Specifically, the processor 110 trains the machine learning model 200 to reproduce a correspondence between the data for input IMa after division, i.e., the data for input IM, and the pre-label LB associated with the data for input IMa after division. Note that having the same number as a suffix means a corresponding relationship between the machine learning model 200 and the input learning data group IDG. In step S12, when the learning of the machine learning model 200 ends, the trained machine learning model 200 is stored in the memory 120.

FIG. 8 is a flowchart illustrating a pre-preparation process of preparing the known feature spectrum groups KSp. When the trained machine learning model 200 is stored in the memory 120, first, the processor 110 in step S20 generates the known feature spectrum groups KSp by, for the M number of trained machine learning models 200_1 to 200_5, inputting the input learning data group IDG, inputting the corresponding input learning data group IDG used in the learning. In step S22, the processor 110 stores the known feature spectrum groups KSp generated in step S20 in the memory 120. The known feature spectrum group KSp is a collection of feature spectrum Sp described below.

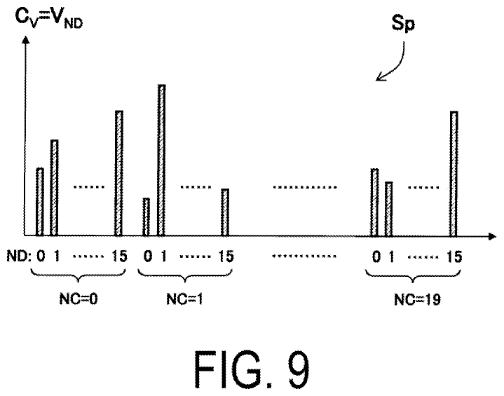

FIG. 9 is an explanatory diagram illustrating the feature spectrum Sp obtained by inputting discretionary data into the trained machine learning model 200. Here, the feature spectrum Sp obtained from the output of the ConvVN1 layer 230 will be described. The horizontal axis in FIG. 9 represents the position of the vector element for the output vector of the plurality of nodes included in one partial region R230 of the ConvVN1 layer 230. The position of the vector element is represented by a combination of an element number ND of the output vector at each node and a channel number NC. In the present embodiment, since the vector dimension is 16, which is the number of elements of the output vector output by each node, the element number ND of the output vector is 16 from 0 to 15. In addition, since the number of channels of the ConvVN1 layer 230 is 20, the channel number NC is 20 from 0 to 19. In other words, the feature spectrum Sp is obtained by arranging a plurality of element values of the output vector of each vector neuron included in one partial region R230 across the plurality of channels along the third axis z.

The vertical axis in FIG. 9 represents a feature value Cᵥ at each spectral position. In this example, the feature value Cᵥ is a value V_{ND} for each element of the output vector. Note that, as the feature value Cᵥ, a value obtained by multiplying the value V_{ND} of each element of the output vector by a normalization coefficient described later may be used, or the normalization coefficient may be used as it is. In the latter case, the number of feature values Cᵥ included in the feature spectrum Sp is equal to the number of channels, which is 20. Note that the normalization coefficient is a value corresponding to a vector length of the output vector at the node.

The number of the feature spectrum Sp obtained from the output of the ConvVN1 layer 230 with respect to one piece of data is equal to the number of plane positions (x, y) of the ConvVN1 layer 230, that is, the number of the partial regions R230, and is thus 6. Similarly, three feature spectra Sp are obtained from the output of the ConvVN2 layer 240 with respect to one piece of data, and one feature spectrum Sp is obtained from the output of the ClassVN layer 250.

When the data for input IMa after division of the input learning data group IDG is input again into the trained machine learning model 200, the similarity calculation unit 310 calculates the feature spectrum Sp illustrated in FIG. 9 and stores the feature spectrum Sp in the memory 120 as the known feature spectrum group KSp.

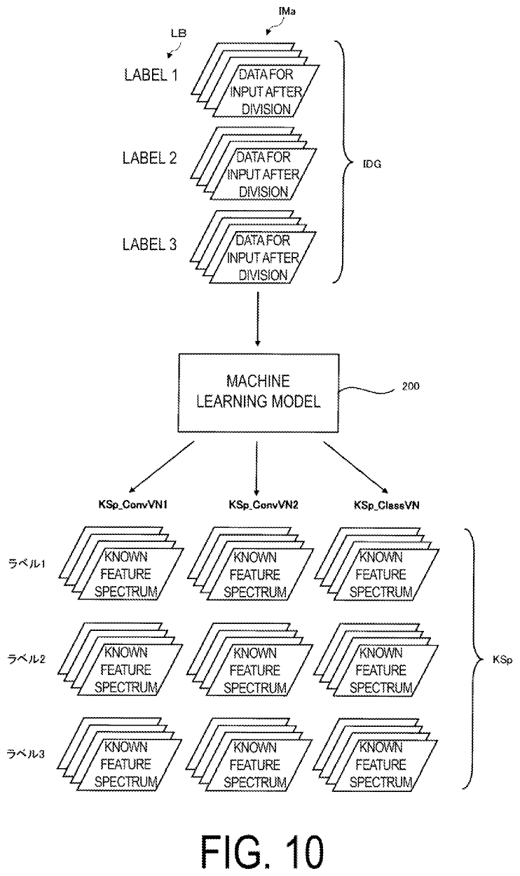

FIG. 10 is an explanatory diagram illustrating how the known feature spectrum group KSp is generated using the input learning data group IDG. In this example, by inputting the data for input IMa after division having a label of 1 to 3 to the trained machine learning model 200, feature spectrum KSp_ConvVN1, KSp_ConvVN2, and KSp_ClassVN associated with the respective labels or classes are obtained from the three vector neuron layers, that is, the outputs of the ConvVN1 layer 230, the ConvVN2 layer 240, and the ClassVN layer 250. These feature spectrum KSp_ConvVN1, KSp_ConvVN2, and KSp_ClassVN are stored as the known feature spectrum group KSp in the memory 120. The similarity calculation unit 310 generates the known feature spectrum groups KSp for each one of the five trained machine learning models 200_1 to 200_5, and causes the memory 120 to store them.

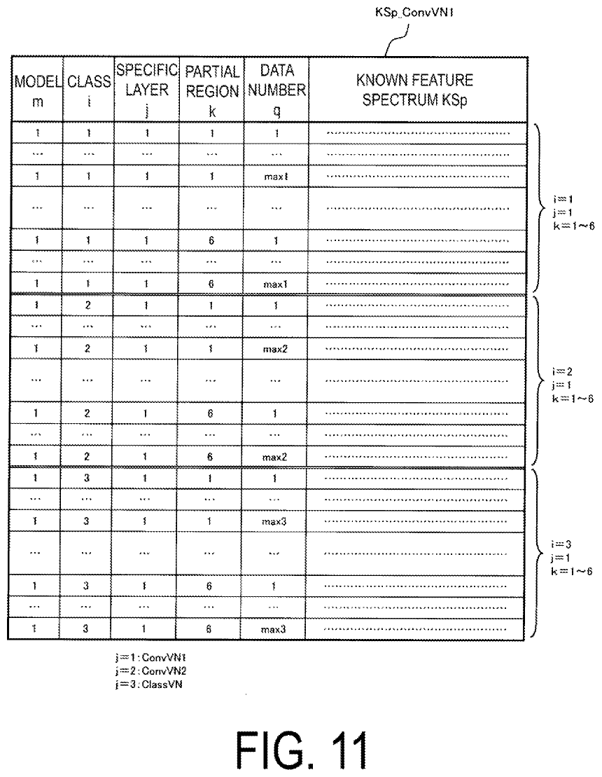

FIG. 11 is an explanatory diagram illustrating a configuration of the known feature spectrum group KSp. In this example, the known feature spectrum group KSp_ConvVN1 obtained from the output of the ConvVN1 layer 230 of the machine learning model 200_1 is illustrated. Although the known feature spectrum group KSp_ConvVN2 obtained from the output of the ConvVN2 layer 240 and the known feature spectrum group KSp_ConvVN1 obtained from the output of the ClassVN layer 250 have the same configuration, an illustration of these is omitted in FIG. 11. Note that it is sufficient that the known feature spectrum group KSp is obtained from the output of a specific layer which is at least one of the vector neuron layers.

Each record of the known feature spectrum group KSp_ConvVN1 includes a parameter m for distinguishing between the M number of machine learning models 200, a parameter i indicating the label or a class, a parameter j indicating the specific layer, a parameter k indicating the partial region Rn, a parameter q indicating the data number, and the known feature spectrum KSp associated with the parameters i, j, k, and q. The known feature spectrum KSp is the same as the feature spectrum Sp of FIG. 9.

The class parameter i is class classification information indicating which class the known feature spectrum KSp belongs to and has the same value of 1 to 3 as the label. The parameter j of the specific layer has a value of 1 to 3 indicating one of the three specific layers 230, 240, and 250. The parameter k of the partial region Rn has a value indicating which one of the plurality of partial regions Rn is included in each specific layer, that is, a value indicating which plane position (x, y). Since the number of partial regions R230 in the ConvVN1 layer 230 is 6, k=1 to 6. The parameter q of the data number indicates the number of the data for input IMa after division to which the same label is attached and has values of 1 to max1 for the class 1, 1 to max2 for the class 2, and 1 to max3 for the class 3. The known feature spectrum KSp associated with the parameter i, which is the class classification information, in this manner is also referred to as the by class known feature spectrum KSp.

As described above, the known feature spectrum groups KSp is obtained from the output of the specific layer by inputting a corresponding input learning data group IDG into each one of the M number of machine learning models 200_1 to 200_5.

Note that the plurality of input learning data groups IDG used in step S20 are not necessarily the same as the plurality of input learning data group IDG used in step S14. However, even in step S20, if some or all of the plurality of input learning data ID used in step S14 are used, there is an advantage that it is not necessary to prepare new input learning data ID.

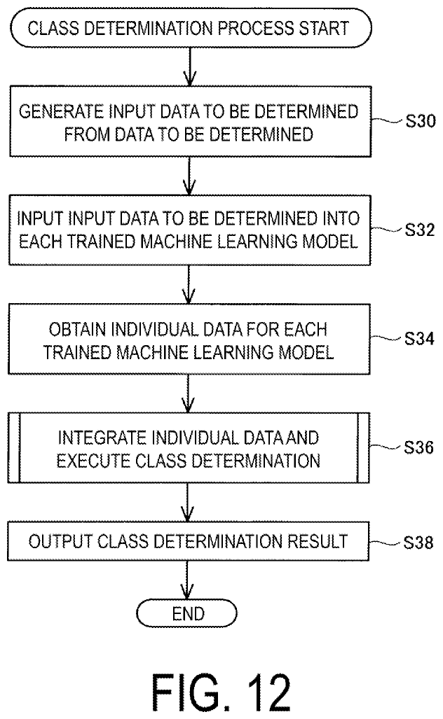

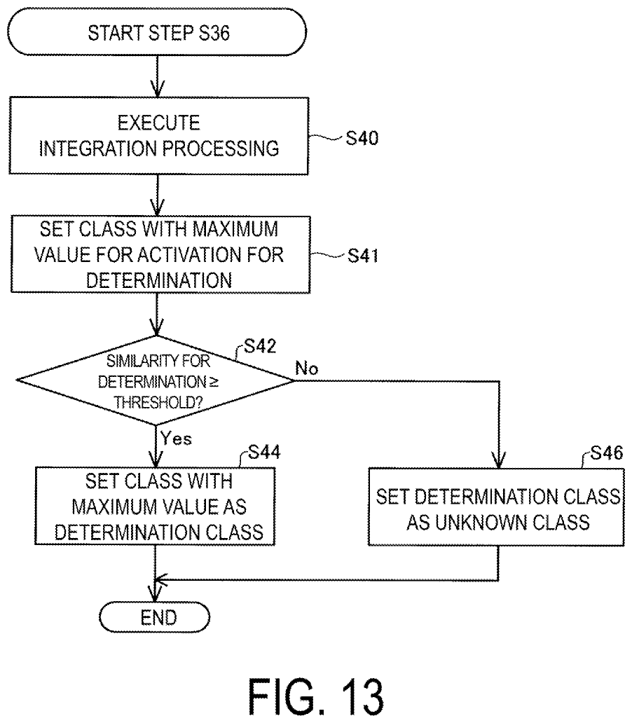

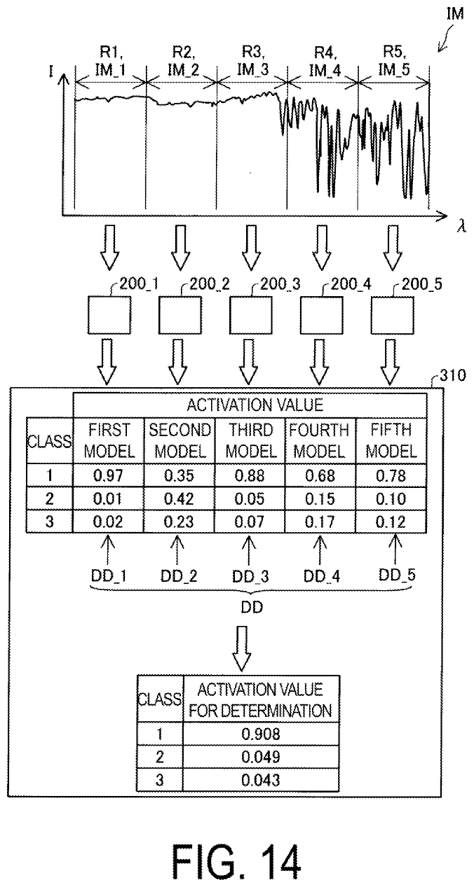

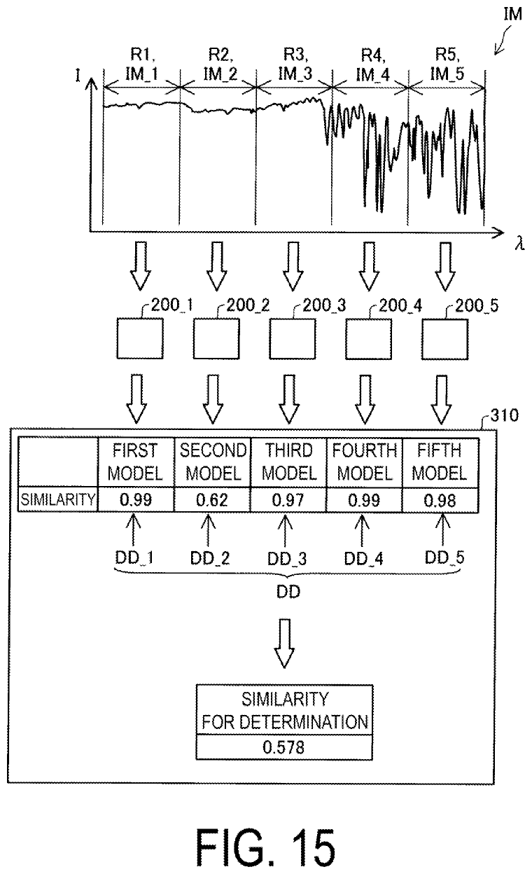

FIG. 12 is a flowchart illustrating a class determination process for the data to be determined IM. FIG. 13 is a detailed flowchart of step S36 of FIG. 12. FIG. 14 is a first drawing for describing the class determination process. FIG. 15 is a second drawing for describing the class determination process.

As illustrated in FIG. 12, in step S30, the data generating unit 112 generates data to be determined for input IM_1 to IM_5 to be input into the machine learning models 200_1 to 200_5 from the data to be determined IM input into the determining apparatus 20. Specifically, as illustrated in FIG. 14, the data generating unit 112 uses a similar data processing method to the generation method of the input learning data ID and generates the data to be determined for input IM_1 to IM_5 from the data to be determined IM. In the present embodiment, with the data to be determined IM being divided into the five regions R1 to R5, the data of each of the regions R1 to R5 after division corresponds to the data to be determined for input IM_1 to IM_5.

As illustrated in FIG. 12, in step S32, the processor 110 inputs the corresponding data to be determined for input IM_1 to IM_5 generated from the data to be determined IM into the M number of trained machine learning models 200_1 to 200_5. Specifically, as illustrated in FIG. 14, the regions R1 to R5 of the input learning data ID used for learning and the data to be determined for input IM_1 to IM_5 of the same regions R1 to R5 are input into the machine learning models 200_1 to 200_5. For example, the data to be determined for input IM 1, which is data of the region R1, is input into the machine learning model 200_1 trained using the data for input IMa_1 after division for region R1 learning.

As illustrated in FIG. 12, in step S34, the similarity calculation unit 310 obtains the individual data DD for each one of the M number of trained machine learning models 200_1 to 200_5. As illustrated in FIGS. 14 and 15, the individual data DD includes, for each one of the first model 200_1 to the fifth model 200_5, the activation value a corresponding to each class and the similarity S. As described above, the activation value a is the determination value Class 1 to Class 3 output from the three channels of the ClassVN layer 250. The similarity S is an index indicating the similarity between the data to be determined for input IM_1 to IM_5 and the data for input IMa_1 to IMa_5 after division relating to each class. The similarity S is, for example, the by class similarity Sclass corresponding to the class with maximum value for the activation value a for the first model 200_1 to the fifth model 200_5. When there are a plurality of specific layers, the similarity calculation unit 310 calculates, for each one of the plurality of specific layers, the multiplication value obtained by multiplying the weighting coefficient set for one specific layer and the similarity S corresponding to that specific layer. Then, the similarity calculation unit 310 generates the similarity S for determining the class by obtaining the sum of the plurality of calculated multiplication values. By setting the weighting coefficient for the plurality of specific layers, when a plurality of specific layers are provided, the similarity S used in class determination can be easily calculated. When referring separately to the five pieces of individual data DD corresponding to the first model 200_1 to the fifth model 200_5, the reference sign DD_1 to DD_5 are used. Note that no such limitation is intended by the foregoing, and the similarity calculation unit 310 may generate a maximum value or a minimum value from among the similarities S corresponding to the specific layers as the similarity S to use in class determination.

As illustrated in FIG. 12, in step S36, the total determination unit 320 integrates the five pieces of individual data DD_1 to DD_5 and executes class determination of the data to be determined IM on the basis of the integration result. After step S36, the total determination unit 320 outputs the class determination result to the display unit 150.

As illustrated in FIG. 13, in step S40, the total determination unit 320 executes integration processing to integrate the five pieces of individual data DD_1 to DD_5. Specifically, the total determination unit 320 executes first integration processing to integrate the activation values a of the five pieces of individual data DD_1 to DD_5 and second integration processing to integrate the similarities S of the five pieces of individual data DD_1 to DD_5.

In the first integration processing, the total determination unit 320 calculates the cumulative activation value by adding together the five activation values a for each of the three classes. Then, as illustrated in FIG. 14, the total determination unit 320 calculates an activation value for determination by applying an activation function to the cumulative activation value of each of the three classes. In the present embodiment, the total determination unit 320 calculates the activation value for determination for each class by applying a softmax function to the three cumulative activation values. Note that the calculation method of the cumulative activation value and the activation value for determination are not limited to that described above. For example, for the activation value for determination, the cumulative activation value of each class may be used as is. Furthermore, for example, the cumulative activation value may be obtained by setting the weighting coefficient for the first model 200_1 to the fifth model 200_5 and finding the sum of the products of the activation values a and the corresponding weighting coefficient.

In the second integration processing, the total determination unit 320 generates a similarity for determination by integrating the respective similarities S calculated for the first model 200_1 to the fifth model 200_5. In the present embodiment, as illustrated in FIG. 15, the total determination unit 320 generates the similarity for determination by multiplying the similarities S. Note that the generation method of the similarity for determination is not limited to the above-described method. For example, the similarity for determination may be a value obtained by dividing the sum of the similarities S by the number of machine learning models 200 or the maximum value or the minimum value from among the similarities S.

As illustrated in FIG. 13, in step 541, the total determination unit 320 sets the class with the highest activation value for determination. In the example illustrated in FIG. 14, the total determination unit 320 sets the class with the highest activation value for determination as the class 1.Next, in step S42, as illustrated in FIG. 13, the total determination unit 320 determines whether or not the similarity for determination is equal to or greater than a predetermined threshold. When the similarity for determination is equal to or greater than a predetermined threshold, in step S44, the total determination unit 320 sets the class with the highest activation value for determination as a determination class. On the other hand, when the similarity for determination is less than a predetermined threshold, the total determination unit 320 sets the determination class, irrespective of the activation value for determination, as an unknown class. The unknown class is a class different from the classes corresponding to a pre-label, and, in the present embodiment, this means that it is different from the classes 1 to 3. As described above, the total determination unit 320 is capable of accurately setting the determination class using the similarity for determination and the activation value for determination.

According to the first embodiment described above, as illustrated in FIGS. 5 to 7, the five machine learning models 200_1 to 200_5 are trained using the five input learning data groups IDG_1 to IDG_5, which are collections of the first type divided input data IDa_1 to IDa_5. This makes it possible to reduce the amount of data of one input learning data group IDG, and thus suppresses the learning from taking a long time. Furthermore, since the data length of one input learning data group IDG can be shortened, when the output of each layer in the machine learning model 200 is calculated, the detailed features of the data can be used without being lumped together as one feature. In this manner, class determination which captures the features of the data in more detail can be executed. Additionally, according to the first embodiment described above, as illustrated in FIGS. 12 to 15, the individual data DD obtained from the plurality of machine learning models 200_1 to 200_5 can be integrated to facilitate class determination.

Note that the total determination unit 320 may omit step S42 and step S46. In other words, the total determination unit 320 may set the class with the highest activation value for determination as the determination class regardless of the magnitude of the similarity for determination. This makes it possible to easily decide the determination class using the activation value for determination without using the similarity for determination.

### B. Other Embodiments of Class Determination Process

The class determination process illustrated in FIGS. 12 and 13 is not limited to the above-described embodiment. Another embodiment of the class determination process will be described below.

B-1. Other Embodiment 1 of Class Determination Process:

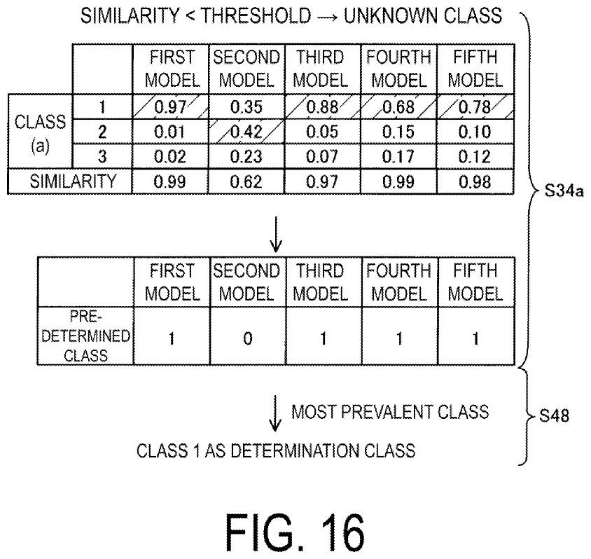

FIG. 16 is a diagram for describing another embodiment 1 of the class determination process. In the present embodiment 1, step S30 and step S32 of FIG. 12 are executed by a similar process, but the steps after step S34 are different.

In step S34a, the similarity calculation unit 310 generates, as an element of the individual data DD and in addition to the activation a corresponding to each class and the similarity S, a pre-determined class using the activation and the similarity S. The similarity calculation unit 310 generates a pre-determined class by executing the following processes (1) and (2).

Process (1):

In this process, for each one of the first model 200_1 to the fifth model 200_5, when the similarity S is equal to or greater than a predetermined threshold, the class corresponding to the activation value a with the highest value from among the activation values a corresponding to the classes is set as the pre-determined class.

Process (2):

In this process, for each one of the first model 200_1 to the fifth model 200_5, when the similarity S is less than a predetermined threshold, an unknown class different from the class corresponding to the pre-label is set as the pre-determined class.

The threshold in the processes (1) and (2) described above are set to a value such that the data to be determined for input IM_1 to IM5 are estimated to be not similar to the data for input IMa_1 to IMa_5 after division relating to each class. In the present embodiment, the threshold is set to 0.7.

As described above, according to the process (1), the class corresponding to the activation value a with the largest value can be set as the pre-determined class. Also, as described above, since an unknown class can be set as a pre-determined class according to the process (2), class determination of the data to be determined IM can be executed with higher accuracy. In the present disclosure, an unknown class is represented by class 0.

By the similarity calculation unit 310 executing the processes (1) and (2) described above in step S34a, class 1 is generated as the pre-determined class for the first model 200_1, class 0, i.e., an unknown class, is generated for the second model 200_2, class 1 is generated for the third model 200_3, class 1 is generated for the fourth model 200_4, and class 1 is generated for the fifth model 200_5.

Next, in step S48, the total determination unit 320 sets the class most prevalent among the pre-determined classes of first model 200_1 to the fifth model 200_5 as the class of the data to be determined IM. This makes it possible to easily determine the class of the data to be determined IM using the pre-determined class.

In the other embodiment 1 of the class determination process described above, the similarity calculation unit 310 determines the pre-determined class taking into account a threshold, but the process is not limited thereto. For example, the similarity calculation unit 310 may, in step S34a, generate a class corresponding to the activation value a with the highest value from among the activation values a corresponding to the classes for the first model 200_1 to the fifth model 200_5, regardless of the magnitude of the similarity S.

B-2. Other Embodiment 2 of Class Determination Process:

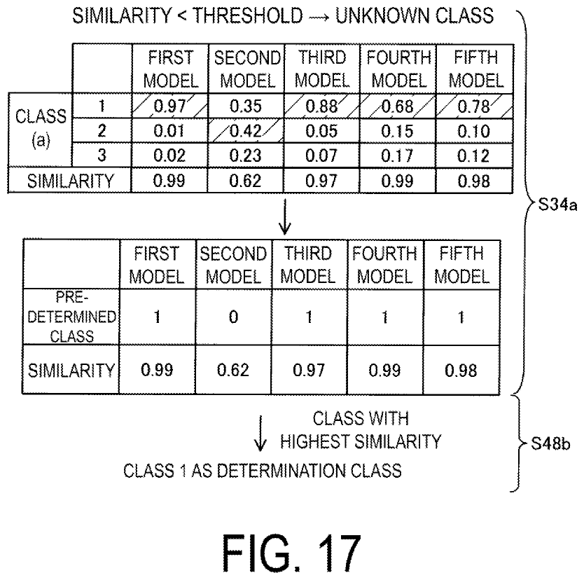

FIG. 17 is a diagram for describing another embodiment 2 of the class determination process. Step S48b described in the embodiment 2 is executed in place of step S48 of FIG. 16.

In step S48b, the total determination unit 320 sets the class with the highest similarity S among the pre-determined classes of first model 200_1 to the fifth model 200_5 as the class of the data to be determined IM. In the example illustrated in FIG. 17, class 1, which is a pre-determined class of first model 200_1 with the highest similarity of 0.99 is set as the determination class. Accordingly, the class with the highest similarity S can be easily determined as the determination class of the data to be determined IM without using the activation value a.

Note that the other embodiment 2 of the class determination process is not limited to that described above. For example, in step S48b, the total determination unit 320 may calculate the sum or product of the similarities S included in the individual data DD for each class of the same pre-determined class and set the pre-determined class with the highest calculated value as the determination class of the data to be determined IM. This will be described using the following examples.

First model . . . (Pre-determined class=Class 1, Similarity S=0.8)

Second Model . . . (Pre-determined class=Class 1, Similarity S=0.7)

Third Model . . . (Pre-determined class=Class 3, Similarity S=0.7)

Fourth Model . . . (Pre-determined class=Class 2, Similarity S=0.9)

Fifth Model . . . (Pre-determined class=Class 2, Similarity S=0.8)

In the case described above, the total determination unit 320 calculates the sum of the similarities S included in the individual data DD for each class of the same pre-determined class, for example. Regarding the sum, the sum of the similarities S of class 1 is 1.5, the sum of the similarities S of class 2 is 1.7, and the sum of the similarities S of class 3 is 0.7. Thus, the total determination unit 320 sets, as the determination class of the data to be determined IM, the class 2 with the highest sum of 1.7. Accordingly, the determination class of the data to be determined IM can be easily determined using the similarity S, without using the activation value a.

B-3. Other Embodiment 3 of Class Determination Process:

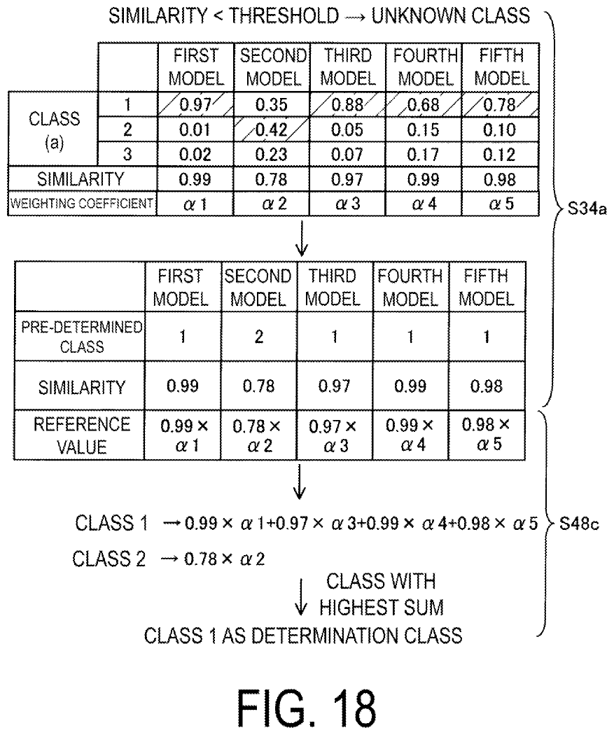

FIG. 18 is a diagram for describing another embodiment 3 of the class determination process. Step S48c described in the embodiment 3 is executed in place of step S48b of FIG. 17. In the embodiment 3, weighting coefficients α1 to α5 are set for the first model 200_1 to the fifth model 200_5. In step S48c, the total determination unit 320 multiplies similarity S and the weighting coefficient α1 to α5 corresponding to the similarity S for the first model 200_1 to the fifth model 200_5 and calculates a reference value. Then, the total determination unit 320 determines the class of the data to be determined IM using the pre-determined class and the reference value. In particular, the total determination unit 320 calculates the sum of the reference values of the machine learning models 200 of the same pre-determined class. Then, the total determination unit 320 sets, as the determination class of the data to be determined IM, the class with the highest sum. Furthermore, in place of the foregoing, the total determination unit 320 may set, as the determination class of the data to be determined IM, the pre-determined class of the machine learning model 200 with the maximum or minimum reference value. Accordingly, the class of the data to be determined can be determined taking into account the weighting coefficient set for each machine learning model 200_1 to 200_5.

B-4. Other Embodiment 4 of Determination Process:

In the other embodiments 1 to 3 of the determination process described above, the total determination unit 320 may set the unknown class as the determination class of the data to be determined IM regardless of the class indicated by the other pre-determined classes when one of the plurality of pre-determined classes corresponding to the plurality of machine learning models 200_1 to 200_5 indicates the unknown class. When one of the plurality of pre-determined classes indicates an unknown class, there may be a likelihood that the data to be determined IM is unknown. Thus, by setting the class of the data to be determined IM to the unknown class when one of the pre-determined class indicates an unknown class, class determination can be executed with higher accuracy.

### C. Other Embodiments of Pre-determined Class Generation Process

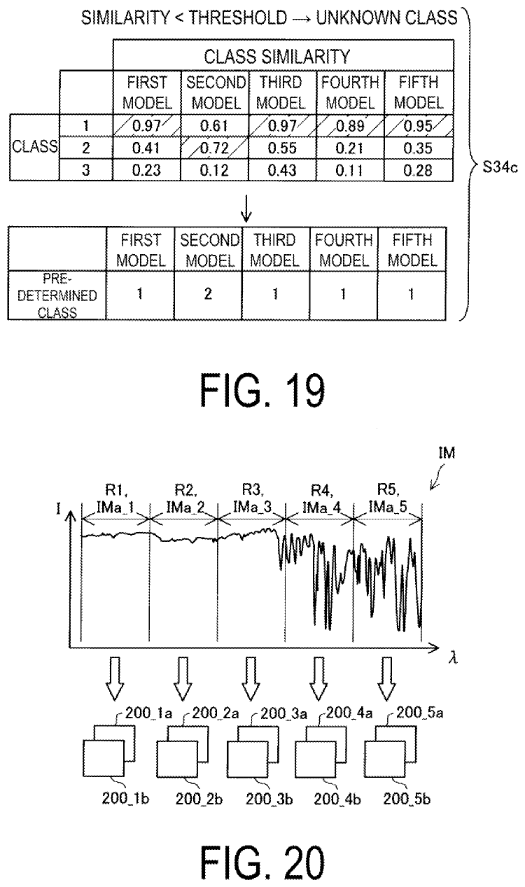

According to another embodiment of the determination process described above, as illustrated in FIGS. 16 to 18, the similarity calculation unit 310 generates pre-determined classes using the similarity S and the activation value a, but the process is not limited thereto. FIG. 19 is a diagram for describing another embodiment of the pre-determined class generation process.

In the other embodiment illustrated in FIG. 19, in step S34c, the similarity calculation unit 310 calculates, for each class of each machine learning model 200_1 to 200_5, the by class similarity Sclass, which is the similarity between the by class known feature spectrum KSp and the feature spectrum KSp of the data to be determined for input IM_1 to IM_5. The similarity calculation unit 310 executes statistical processing of the plurality of similarities S calculated for each class and calculates, as the by class similarity Sclass, a representative similarity, which is a representative value of the plurality of similarities S for each class. The expression “representative value obtained by statistical processing” means the maximum value, the median value, the average value, or the modal value. This representative similarity is used for pre-determined class generation described below. Note that the calculation method of the by class similarity Sclass is described below in detail.

Next, the similarity calculation unit 310 generates, as a pre-determined class as an element of the individual data DD, a class associated with the representative similarity with the highest value from among the representative similarities of the by class similarity Sclass calculated for each class. In this manner, the pre-determined class can be easily generated using the by class similarity Sclass, without using the activation value a. Here, when the representative similarity with the highest value is less than a predetermined threshold, instead of the class associated with the representative similarity, an unknown class different from a class corresponding to a pre-label is generated as the pre-determined class as an element of the individual data. In this manner, an unknown class can be generated as the pre-determination class, and thus a pre-determined class can be generated with higher accuracy. In the present embodiment, the predetermined threshold is set to 0.7 as in the processes (1) and (2) described above.

### D. Other Embodiments of First Embodiment

FIG. 20 is a diagram for describing another embodiment of the first embodiment. In the first embodiment described above, as illustrated in FIG. 14, the machine learning models 200_1 to 200_5 each correspond to one of the regions R1 to R5, but a plurality of machine learning models may be provided corresponding to each one of the regions R1 to R5. In the example illustrated in FIG. 20, two machine learning models 200 are trained corresponding to each of the regions R1 to R5 and used for class determination. When referring separately to the two machine learning models 200_1 to 200_5 corresponding to each of the regions R1 to R5, the suffix “a” or “b” is attached at the end. In the learning step, the data generating unit 112 divides the plurality of input learning data groups IDG included in the input learning data groups IDG_1 to IDG_5 corresponding to one region R1 to R5 into two groups. For example, the data generating unit 112 divides the plurality of input learning data groups IDG into two even groups. When training the machine learning model 200_1a and 200_1b, one of the two divided input learning data groups IDG is input into the machine learning model 200_1a and the other is input into the machine learning model 200_1b to train the two machine learning models 200-1a and 200-1b.

In the class determination process, first, the similarity calculation unit 310 obtains the individual data DD by inputting the data to be determined for input IM_1 to IM_5 into the corresponding two machine learning models 200. Next, the similarity calculation unit 310 sets which individual data DD of the two machine learning models 200 corresponding to each regions R1 to R5 to use in class determination. Specifically, the similarity calculation unit 310 calculates a model reliability Rmodel that depends on the similarity S included in the individual data DD and sets the individual data DD obtained from the machine learning model 200 with the highest model reliability Rmodel as the data to be used in class determination. By executing integration processing via the first integration processing and the second integration processing in a similar manner as in the first embodiment described above, the activation value for determination and the similarity for determination is calculated for the five pieces of individual data DD used in class determination set for each region R1 to R5. In addition, as in the first embodiment, the total determination unit 320 sets the determination class from the activation value for determination and the similarity for determination. Note that the setting method for setting the individual data DD obtained from the machine learning model 200 with the highest model reliability Rmodel as the data to be used in class determination can be applied to other embodiments of the present disclosure. For example, in the first embodiment illustrated in FIG. 2, which individual data DD of the five machine learning models 200_1 to 200_5 to use in class determination is set by the setting method described above.

For example, any of the following can be used as a reliability function for obtaining the model reliability R from the similarity S.

Rmodel(i)=H1[S(i)]=S(i) (3a)

Rmodel(i)=H2[S(i)]=Ac(i)×Wt+S(i)×(1−Wt) (3b)

Rmodel(i)=H3[S(i)]=Ac(i)×S(i) (3c)

where Ac(i) is an activation value corresponding to the determination value with the highest value in the output layer of the machine learning model 200, and Wt is the weighting coefficient ranging from 0<Wt<1.

The reliability function H1 of the above-described Equation (3a) is an identity function using the similarity S as is as the model reliability Rmodel. The reliability function H2 of the above-described Equation (3b) is a function for obtaining the model reliability Rmodel by finding the weighted average of the similarity S and the activation value Ac. The reliability function H3 of the above-described Equation (3c) is a function for obtaining the model reliability Rmodel by multiplying the similarity S and the activation value Ac. Other reliability functions may also be used. For example, a function may be used in which a power of the similarity S is used as the model reliability Rmodel. Thus, a model reliability Rmodel can be obtained that is dependent on the similarity S. Additionally, the model reliability Rmodel preferably has a positive correlation to the similarity S.

In the first embodiment described above, data for input is divided into M or more number of regions, and a collection of the first type of divided input data IDa after division that belongs in the same region is generated as one input learning data group IDG by the data generating unit 112 as first data processing. However, the first data processing may include, as the first data processing, dividing into one or more or two or more regions to generate, as one input learning data group IDG, a collection of the first type divided input data IDa after division that belong in the same region. In this case, the same input learning data group IDG may be input into at least two models of the M number of machine learning models 200. Since the performance of the machine learning model 200 with each training may change with the same input learning data, a plurality of the machine learning models 200 trained with the same input learning data may be used. With known techniques, when a single machine learning model is trained and class determination of the data to be determined IM is performed, the determination accuracy may be reduced. However, according to the first embodiment and the other embodiments of the first embodiment described above, since class determination is performed using the plurality of machine learning models 200 with different class determination performances, class determination accuracy can be improved. Such an effect can also be achieved by the second embodiment described below.

### E. Second Embodiment

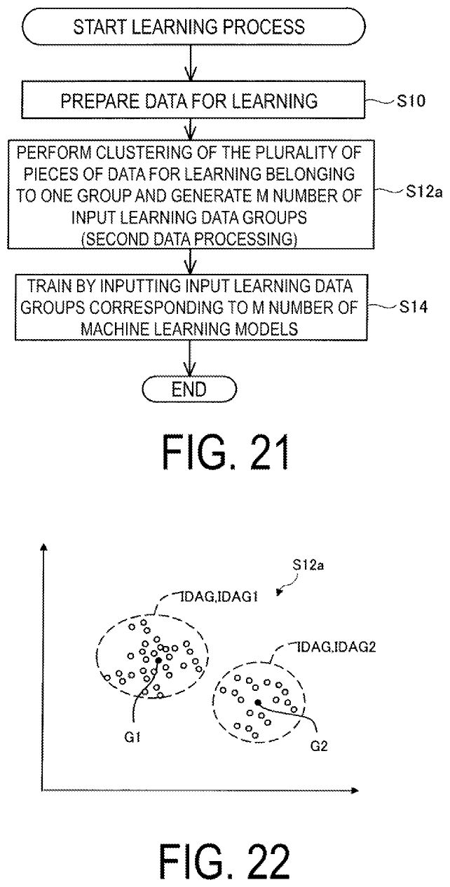

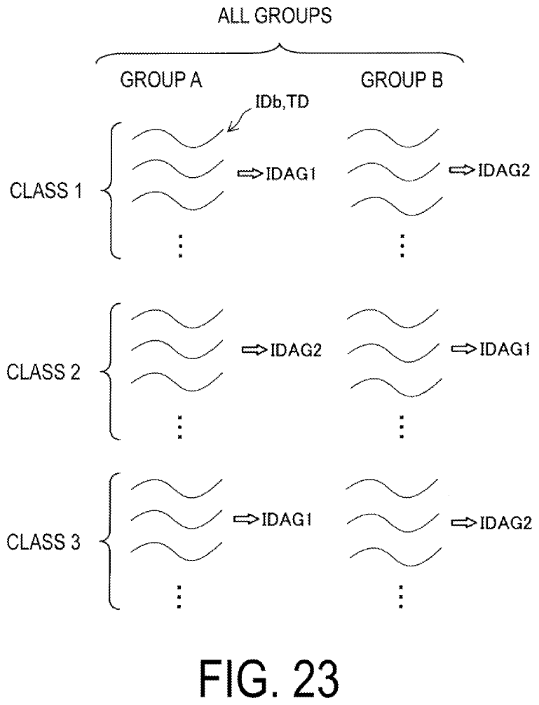

FIG. 21 is a flowchart illustrating a learning process according to the second embodiment. FIG. 22 is a conceptual diagram of clustering. FIG. 23 is a diagram for describing step S12a. In the second embodiment, a determination system 5 similar to that of the first embodiment is used. Note that in the second embodiment, the number of machine learning models 200 illustrated in FIG. 2 is two. When the two machine learning models 200 are referred to separately, the reference signs 200_1 and 200_2 are used. Also, the difference between the learning process of the second embodiment and the learning process of the first embodiment illustrated in FIG. 5 is the step S12a. Thus, for the learning process, the same steps that are in both the first embodiment and the second embodiment are given the same reference sign and descriptions thereof are omitted.

As illustrated in FIG. 21, in step S12a, the data generating unit 112 executes the second data processing. Specifically, the data generating unit 112 divides the plurality of data for learning TD belonging to one class into two groups via clustering and generates an input learning data group IDAG, which is a collection of input learning data IDA as second type divided input data after division. In the present embodiment, two input learning data groups IDAG are generated. Note that the same input learning data ID may be sorted and exist in both of the two clusters after division. One of the two input learning data groups IDAG may also be referred to as a first input learning data group IDAG1, and the other may also be referred to as a second input learning data group IDAG2. The first input learning data group IDAG1 is used to train the machine learning model 200_1. The second input learning data group IDAG2 is used to train the machine learning model 200_2. In clustering, the k-means method is used, for example. In the case of using the k-means method, the input learning data groups IDAG1 and IDAG2 have representative points G1 and G2 that represent the respective input learning data groups IDAG1 and IDAG2. These representative points G1 and G2 are, for example, the centroid. Note that, instead of the clustering of step S12a described above, the second data processing may be executed by extracting the plurality of data for learning TD belonging to one class randomly by sampling with replacement. By extracting the plurality of data for learning TD randomly via sampling with replacement, two groups that are collections of data for learning TD are generated.

As illustrated in FIG. 23, two groups, groups A and B, are generated by clustering or sampling with replacement for each class 1 to 3. The two groups A and B are not particularly limited in terms of how they are allocated to the first input learning data group IDAG1 and the second input learning data group IDAG2. For example, for each class 1 to 3, the data generating unit 112 may randomly allocate one group to the first input learning data group IDAG1 and the other group to the second input learning data group IDAG2. Furthermore, for example, for each class 1 to 3, the data generating unit 112 may allocate groups with a close Euclidean distance between the representative points G1 and G2 to the same input learning data group IDAG. For example, when the Euclidean distance between the representative point G1 of group A of class 1 and the representative point G1 of group A of class 2 is closer than the Euclidean distance between the representative point G1 of group A of class 1 and the representative point G2 of group B of class 2, the data generating unit 112 allocates group A of class 1 and group A of class 2 to the same input learning data group IDAG. Note that the allocation method for class 3 is similar to that of class 2. Also, the index used when allocating to the same input learning data group IDAG is not limited to the Euclidean distance, and cos similarity, the Mahalanobis distance, or the like may be used.

In the second embodiment also, the pre-preparation process illustrated in FIG. 8 and the determination process illustrated in FIG. 12 is executed as described in the first embodiment. In this case, in step S30 of the determination process illustrated in FIG. 12, the data to be determined IM is generated as the data to be determined for input IM without being divided. Then, in step S32 and step S34, the processor 110 obtains the individual data DD from the trained machine learning models 200_1 and 200_2 by inputting one data to be determined for input IM into the two machine learning models 200_1 and 200_2.

According to the second embodiment described above, as illustrated in FIGS. 21 to 23, the single machine learning model 200 is trained using the input learning data group IDG, which is a collection of the second type divided input data IDb. This makes it possible to reduce the amount of data of one input learning data group IDG, and thus suppresses the learning of each machine learning model 200 from taking a long time. Additionally, according to the second embodiment described above, as in the first embodiment, the individual data DD obtained from the plurality of machine learning models 200 can be integrated to facilitate class determination. Further, by integrating the individual data DDs obtained from the plurality of machine learning models 200 and performing class determination, it can be expected that each machine learning model 200 recognizes and discriminates between different features, allowing for highly accurate class determination to be executed taking into account more multifaceted features.

### F. Other Embodiments of Second Embodiment

In the second embodiment described above, as the second data processing, the data generating unit 112 executes division processing to divide the plurality of data for input IM belonging to one class into M or more number of pieces and generates a collection of the second type divided input data IDb after division as one input learning data group IDG. However, the second data processing may include dividing the plurality of data for learning TD belonging to one class into one or more or two or more groups to generate, as one input learning data group IDG, a collection of the second type divided input data IDb after division. For example, the plurality of data for learning TD belonging to one class are referred to data for learning TD1, TD2, and TD3. In this case, the following seven input learning data groups IDG are generated. For each machine learning model 200_1 and 200_2, one or more data group is selected from the following generated seven input learning data groups IDG and used in learning.

(1) First input learning data group . . . Configuration by data for learning TD1.

(2) Second input learning data group . . . Configuration by data for learning TD2.

(3) Third input learning data group . . . Configuration by data for learning TD3.

(4) Fourth input learning data group . . . Configuration by data for learning TD1 and TD2.

(5) Fifth input learning data group . . . Configuration by data for learning TD1 and TD3.

(6) Sixth input learning data group . . . Configuration by data for learning TD2 and TD3.

(7) Seventh input learning data group . . . Configuration by data for learning TD1, TD2, and TD3.

Note that since the performance of the machine learning models 200_1 and 200_2 with each training may change with the same input learning data, a plurality of the machine learning models 200 trained with the same input learning data may be used. That is, in the second data processing, the plurality of learning data TD belonging to one class may be divided into one or more group regardless of the number of machine learning models 200.

### G. Calculation Method of Similarity

Any one of following three methods can be used as the calculation method of the by class similarity Sclass described above, for example.

(1) First calculation method M1 for obtaining by class similarity Sclass without considering correspondence between the partial regions Rn in the feature spectrum Sp and the known feature spectrum group KSp

(2) Second calculation method M2 for obtaining by class similarity Sclass based on the corresponding partial regions Rn in the feature spectrum Sp and the known feature spectrum group KSp

(3) Third calculation method M3 for obtaining by class similarity Sclass without considering the partial regions Rn at all

Hereinafter, a method of calculating the by class similarity Sclass_ConvVN1 from the output of the ConvVN1 layer 230 according to the three calculation methods M1, M2, and M3 will be sequentially described. Note that in the following description, the parameter m of the machine learning model 200 and the parameter q of the data to be determined IM are omitted.

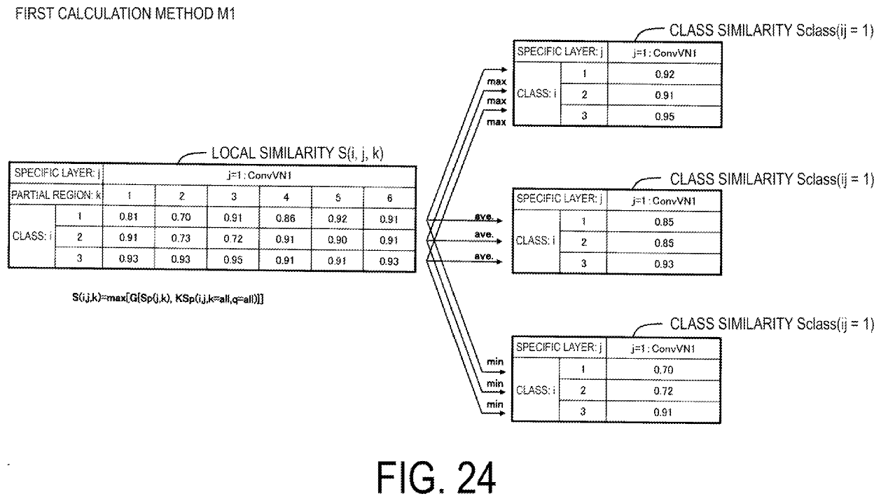

FIG. 24 is an explanatory diagram illustrating a first calculation method M1 for the by class similarity. In the first calculation method M1, first, a local similarity S(i, j, k) indicating the similarity with each class for each partial region k is calculated from the output of the ConvVN1 layer 230, which is the specific layer. Then, from these local similarities S(i, j, k), any of three types of class similarities Sclass(i, j) illustrated on the right side of FIG. 24 is calculated.

In the first calculation method Ml, the local similarity S(i, j, k) is calculated using the following equation. S(i, j, k)=max[G{Sp(j, k), KSp(i, j, k=all, q=all)}] (c1)

where i is a parameter indicating the class,

j is a parameter indicating the specific layer,

k is a parameter indicating the partial region Rn,

q is a parameter indicating the data number,

G{a, b} is a function for obtaining the similarity between a and b,

Sp(j,k) is a feature spectrum obtained from the output of a specific partial region k of the specific layer j according to the data to be determined,

Ksp(i, j, k=all, q=all) is, from the known feature spectrum group KSp illustrated in FIG. 11, a known feature spectrum of all of the data numbers q in all of the partial regions k of the specific layer j associated with the class i, and

max[X] is a logical calculation that takes the maximum value of the values of X.

Note that for the function G{a, b} for obtaining the similarity, for example, a formula for obtaining cosine similarity, a formula for obtaining similarity corresponding to distance, or the like can be used.

The three types of class similarities Sclass(i, j) illustrated on the right side of FIG. 24 are each calculated as a representative similarity by executing statistical processing of local similarities S(i, j, k) for the plurality of partial regions k for each class i. The statistical processing is executed by taking a maximum value, an average value, or a minimum value of the plurality of local similarities S(i, j, k). Although not illustrated, the by class similarity Sclass may be obtained by taking the modal value of the local similarities S(i, j, k) for the plurality of partial regions k. The use of calculation of the maximum value, the average value, the minimum value, or the modal value will vary depending on the purpose of the class determination processing. For example, when the purpose is to determine an object using a natural image, the by class similarity Sclass(i, j) is preferably obtained by taking the maximum value of the local similarities S(i, j, k) for each class i. In addition, when the purpose is to determine the type of the target object 10 or when the purpose is to determine acceptability using an image of an industrial product, the by class similarity Sclass(i, j) is preferably obtained by taking the minimum value of the local similarity S(i, j, k) for each class i. Also, a case where the by class similarity Sclass(i, j) is preferably obtained by taking the average value of the local similarity S(i, j, k) for each class i is also plausible. The use of these four types of calculations is set in advance by the user experimentally or empirically.

As described above, in the first calculation method Ml for the by class similarity,

(1) the local similarity S(i, j, k) which is the similarity between the feature spectrum Sp obtained from the output of the specific partial region k of the specific layer j according to the data to be determined IM and all of the known feature spectrum KSp associated with the specific layer j and each class i is obtained, and

(2) the by class similarity Sclass(i, j) is obtained by taking the maximum value, the average value, the minimum value, or the modal value of the local similarity S(i, j, k) for the plurality of partial regions k for each class i. According to the first calculation method Ml, the by class similarity Sclass(i, j) can be obtained by a relatively simple calculation and process.

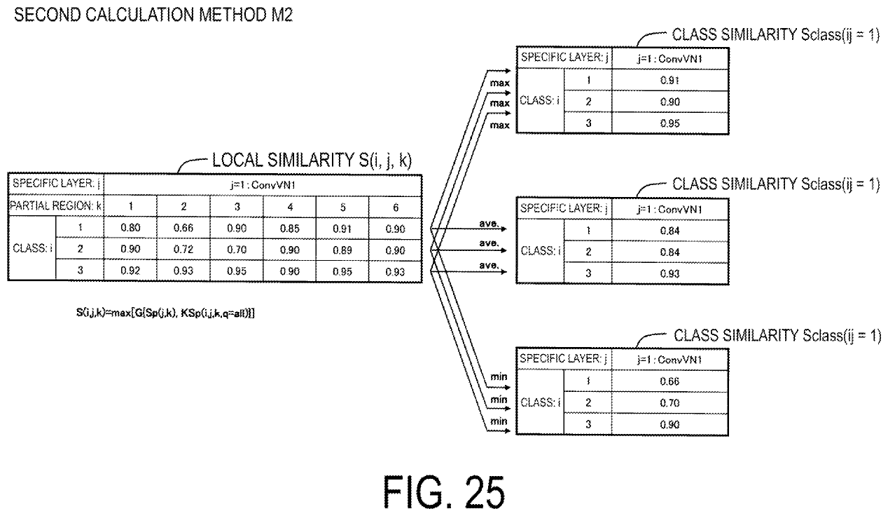

FIG. 25 is an explanatory diagram illustrating a second calculation method M2 for the by class similarity. In the second calculation method M2, the local similarity S(i, j, k) is calculated using the following equation instead of Equation (c1) described above. S(i, j, k)=max[G{Sp(j, k), KSp(i, j, k, q=all)}](c2)

where KSp(i, j, k, q=all) is the known feature spectrum of all the data numbers q in the specific partial region k of the specific layer j associated with the class i in the known feature spectrum group KSp illustrated in FIG. 10.

In the first calculation method M1 described above, the known feature spectrum KSp(i, j, k=all, q=all) in all of the partial regions k of the specific layer j is used. However, in the second calculation method M2, only the partial region k of the feature spectrum Sp(j, k) and the known feature spectrum KSp(i, j, k, q=all) for the same partial region k are used. The other methods in the second calculation method M2 are the same as in the first calculation method M1.

In the second calculation method M2 for the by class similarity,

(1) the local similarity S(i, j, k) which is the similarity between the feature spectrum Sp obtained from the output of the specific partial region k of the specific layer j according to the data to be determined IM and all of the known feature spectrum KSp associated with the specific partial region k of the specific layer j and each class i is obtained, and

(2) the by class similarity Sclass(i, j) is obtained by taking the maximum value, the average value, the minimum value, or the modal value of the local similarity S(i, j, k) for the plurality of partial regions k for each class i. According to the second calculation method M2 also, the by class similarity Sclass(i, j) can be obtained by a relatively simple calculation and process.

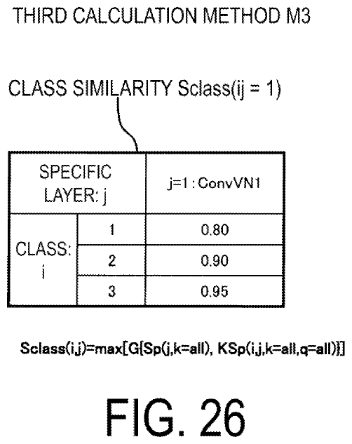

FIG. 26 is an explanatory diagram illustrating a third calculation method M3 for the by class similarity. In the third calculation method M3, the by class similarity Sclass(i, j) is calculated from the output of the ConvVN1 layer 230, which is the specific layer, without obtaining the local similarity S(i, j, k).

The by class similarity Sclass(i, j) obtained via the third calculation method M3 is calculated using the following equation.

Sclass(i, j)=max[G{Sp(j, k=all), KSp(i, j, k,=all, q=all)}] (c3)

where Sp(j, k=all) is the feature spectrum obtained from the output of all of the partial regions k of the specific layer j according to the data to be determined IM.

As described above, in the third calculation method M3 for the by class similarity,

(1) the by class similarity Sclass(i, j) which is the similarity between all of the feature spectrums Sp obtained from the output of the specific layer j according to the data to be determined IM and all of the known feature spectrum KSp associated with the specific layer j and each class i is obtained.

According to the third calculation method M3, the by class similarity Sclass(i, j) can be obtained by an even simpler calculation and process.

### H. Calculation Method for Output Vector of Each Layer in Machine Learning Model

The calculation method for the output vector of each layer in the machine learning model 200 illustrated in FIG. 3 is as follows. The machine learning model 200 illustrated in FIG. 4 is also the same except for the values of individual parameters.

In each node of the PrimeVN layer 220, a scalar output of 1×1×32 nodes in the Conv layer 210 is regarded as a 32-dimensional vector, and a vector output at the node is obtained by multiplying this vector by a transformation matrix. The transformation matrix is an element of a kernel having a surface size of 1×1 and is updated by the learning of the machine learning model 200. Note that the processing of the Conv layer 210 and the processing of the PrimeVN layer 220 can be integrated to form one primary vector neuron layer.

When the PrimeVN layer 220 is referred to as a “lower layer L” and the ConvVN1 layer 230 adjacent to an upper side thereof is referred to as an “upper layer L+1”, the output at each node of the upper layer L+1 is determined using the following equation.

$$[ Mathematical Equation 1 ]$$

$$[ Math . 1 ]$$

$${v}_{ij} = {W}_{ij}^{L} {M}_{i}^{L} \qquad ( E1 )$$

$${u}_{j} = {\sum }_{i} {v}_{ij} \qquad ( E2 )$$

$${α}_{j} = F ( ‖ {u}_{j} ‖ ) \qquad ( E3 )$$

$${M}_{j}^{L + 1} = {a}_{j} \times \frac{1}{‖ {u}_{j} ‖} {u}_{j} . \qquad ( E4 )$$

Here, M^{L}ᵢ is an output vector of the ith node in the lower layer L,

M^{L+1}ⱼ is an output vector of the jth node in the upper layer L+1,

vᵢⱼ is a prediction vector of the output vector M^{L+1}ⱼ,

W^{L}ᵢⱼ is a prediction matrix for calculating the prediction vector vᵢⱼ from the output vector M^{L}ᵢ in the lower layer L,

uⱼ is the sum of the prediction vectors vᵢⱼ, that is, a sum vector, which is a linear combination,

aⱼ is an activation value, which is a normalization coefficient obtained by normalizing a norm |uⱼ| of the sum vector uⱼ, and

F(X) is a normalization function for normalizing X.

As the normalization function F(X), for example, the following Equations (E3a) or (E3b) can be used.

$$[ Mathematical Equation 2 ]$$

$$[ Math . 2 ]$$

$${a}_{j} = F ( ‖ {u}_{j} ‖ ) = softmax ( ‖ {u}_{j} ‖ ) = \frac{exp ( β ( ‖ {u}_{j} ‖ )}{{\sum }_{k} exp ( β ( ‖ {u}_{j} ‖ )} \qquad ( E3a )$$

$${a}_{j} = F ( ‖ {u}_{j} ‖ ) = \frac{( ‖ {u}_{j} ‖ )}{{\sum }_{k} ‖ {u}_{k} ‖} . \qquad ( E3b )$$

Here, k is an ordinal number for all the nodes in the upper layer L+1, and

β is an adjustment parameter which is an optional positive coefficient, for example, β=1.

In the above-described Equation (E3a), the activation value aⱼ is obtained by normalizing the norm |uⱼ| of the sum vector uⱼ with a softmax function for all the nodes in the upper layer L+1. On the other hand, in Equation (E3b), the activation value aⱼ is obtained by dividing the norm |uⱼ| of the sum vector uⱼ by the sum of the norms |uⱼ| for all the nodes in the upper layer L+1. Note that, as the normalization function F(X), a function other than Equations (E3a) and (E3b) may be used.

The ordinal number i in the above-described Equation (E2) is, for the sake of convenience, assigned to the node in the lower layer L used to determine the output vector M^{L+1}ⱼ at the jth node in the upper layer L+1 and takes a value from 1 to n. Also, an integer n is the number of nodes in the lower layer L used to determine the output vector M^{L+1}ⱼ in the jth node in the upper layer L+1. Thus, the integer n is given by the following equation.

n=Nk×Nc (E5)

Here, Nk is the surface size of the kernel, and Nc is the number of channels in the PrimeVN layer 220 which is the lower layer. In the example of FIG. 3, since Nk=5 and Nc=26, n=130.

One kernel used to obtain the output vector in ConvVN1 layer 230 has 1×5×26=130 elements with a kernel size of 1×5 as the surface size and a number of channels of 26 in the lower layer as the depth, and each of these elements is the prediction matrix W^{L}ᵢⱼ. Also, in order to generate the output vectors having 20 channels in the ConvVN1 layer 230, 20 sets of these kernels are necessary. Therefore, the number of prediction matrices W^{L}ᵢⱼ of the kernel used to obtain the output vector in the ConvVN1 layer 230 is 130×20=2600. These prediction matrices W^{L}ᵢⱼ are updated by the learning of the machine learning model 200.

As can be seen from the above-described Equations (E1) to (E4), the output vector M^{L}ⱼ at each node in the upper layer L+1 is obtained by the following calculation.

(a) The prediction vector vᵢⱼ is obtained by multiplying the output vector M^{L}ᵢ at each node in the lower layer L by the prediction matrix W^{L}ᵢⱼ,

(b) the sum vector uⱼ, which is the sum of the prediction vectors vᵢⱼ obtained from each node in the lower layer L, that is, the linear combination, is obtained,

(c) the activation value uⱼ, which is the normalization coefficient obtained by normalizing the norm |uⱼ| of the sum vector uⱼ, is obtained, and

(d) the sum vector uⱼ is divided by the norm |uⱼ| and further multiplied by the activation value aⱼ.

Note that the activation value aⱼ is a normalization coefficient obtained by normalizing the norm |uⱼ| for all the nodes in the upper layer L+1. Thus, the activation value aⱼ can be considered as an index indicating a relative output intensity at each node among all the nodes in the upper layer L+1. The norm used in Equations (E3), (E3a), (E3b), and (4) is an L2 norm indicating a vector length in a typical example. At this time, the activation value aⱼ corresponds to the vector length of the output vector M^{L+1}ⱼ. Since the activation value aⱼ is only used in the above-described Equations (E3) and (E4), it is not necessary to be output from the node. However, it is also possible to configure the upper layer L+1 to output the activation value aⱼ to the outside.

The configuration of a vector neural network is almost the same as the configuration of a capsule network, and a vector neuron of a vector neural network corresponds to a capsule of a capsule network. However, the calculation according to the above-described Equations (E1) to (E4) used in the vector neural network is different from calculation used in the capsule network. The biggest difference between the two networks is that in the capsule network, the prediction vector vᵢⱼ on the right side of the above-described Equation (E2) is multiplied by a weight, and the weight is searched by repeating dynamic routing a plurality of times. On the other hand, in the vector neural network of the present embodiment, since the output vector M^{L+1}ⱼ can be obtained by calculating the above-described Equations (E1) to (E4) once in order, there is an advantage in that it is not necessary to repeat the dynamic routing and the calculation is faster. In addition, in the vector neural network of the present embodiment, the amount of memory required for calculation is smaller than that of the capsule network, and, according to an experiment of the inventor of the present disclosure, there is an advantage in that a sufficient amount of memory is from approximately ½ to ⅓.

In terms of using a node at which a vector is input and output, the vector neural network is the same as the capsule network. Thus, the advantages of using the vector neuron are also common to the capsule network. In addition, regarding the feature of a larger region being expressed as the position is higher, and the feature of a smaller region being expressed as the position is lower in the plurality of layers 210 to 250, the vector neural network is the same as a normal convolutional neural network. Here, the term “feature” means a characteristic portion included in the input data to a neural network. Regarding the output vector at a certain node including spatial information representing spatial information of the feature represented by the node, the vector neural network and the capsule network are superior to the normal convolutional neural network. That is, the vector length of the output vector at the certain node represents an existence probability of the feature represented by the node, and a vector direction represents the spatial information such as a direction and a scale of the feature. Accordingly, vector directions of the output vectors at two nodes belonging to the same layer represent a positional relationship between the respective features. Alternatively, it can be said that the vector directions of the output vectors at two nodes represent a variation of the features. For example, in the case of a node corresponding to a feature of an “eye”, the direction of the output vector may represent variations such as the narrowness of the eye, the way the eye rises, and the like. In a normal convolutional neural network, it is said that the spatial information of the feature is lost via pooling processing. As a result, there is an advantage in that the vector neural network and the capsule network have excellent performance in identifying the input data compared with a normal convolutional neural network.

The advantages of vector neural networks can also be thought of as follows. That is, in the vector neural network, there is an advantage in that the output vector at the node expresses the feature of the input data as coordinates in a continuous space. Thus, the output vector can be evaluated such that the features are similar if the vector directions are close. In addition, there is also an advantage in that even if the feature included in the input data is not covered by the training data, the feature can be determined by interpolation. On the other hand, since a normal convolutional neural network is subjected to random compression by the pooling processing, there is a disadvantage in that the features of the input data cannot be expressed as the coordinates in the continuous space.

Since the outputs at the nodes in the ConvVN2 layer 240 and the ClassVN layer 250 are also determined in the same manner by using the above-described Equations (E1) to (E4), a detailed description thereof will be omitted. The resolution of the ClassVN layer 250, which is the uppermost layer, is 1×1, and the number of channels is n1.

The output of the ClassVN layer 250 is converted into a plurality of determination values Class 0 to Class 2 for the known classes. These determination values are typically values normalized by the softmax function. Specifically, for example, the determination value for each class can be obtained by executing a calculation including calculating the vector length of the output vector from the output vector at each node in the ClassVN layer 250 and normalizing the vector length of each node by the softmax function. As described above, the activation value aⱼ obtained by the above-described Equation (E3) is a value corresponding to the vector length of the output vector M^{L+1}ⱼ and is normalized. Accordingly, the activation value aⱼ at each node in the ClassVN layer 250 may be output and used as is as the determination value for each class.

In the embodiment described above, as the machine learning model 200, the vector neural network for obtaining the output vector by the calculation of the above-described Equations (E1) to (E4) is used, but instead, the capsule network described in U.S. Pat. No. 5,210,798 and WO 2009/083553 may be used.

I. Other Aspects:

The present disclosure is not limited to the embodiments described above, and may be implemented in various aspects without departing from the spirits of the disclosure. For example, the present disclosure can be achieved in aspects described below. Appropriate replacements or combinations may be made to the technical features in the above-described embodiments which correspond to the technical features in the aspects described below to solve some or all of the problems of the disclosure or to achieve some or all of the advantageous effects of the disclosure. Additionally, when the technical features are not described herein as essential technical features, such technical features may be deleted appropriately.

(1) According to a first aspect of the present disclosure, a learning method for M (an integer of two or more) number of vector neural network type machine learning models including a plurality of vector neuron layers, the M number of machine learning models being used in determining a class of data to be determined is provided. The learning method includes (a) preparing a plurality of pieces of data for learning including data for input and a pre-label associated with the data for input; (b) dividing the plurality of pieces of data for learning into one or more groups to generate one or more input learning data groups; and (c) training the M number of machine learning models so that a correspondence between the data for input and the pre-label associated with the data for input is reproduced, by inputting the corresponding input learning data groups respectively into the M number of machine learning models, wherein (b) includes (b1) dividing the plurality of pieces of data for input into one or more regions to generate, as one of the input learning data groups, a collection of first type divided input data after division belonging to the same region, or (b2) dividing the plurality of pieces of data for learning belonging to one class into one or more groups to generate, as one of the input learning data groups, a collection of second type divided input data after division.

According to this aspect, a collection of first type divided input data can be used as one input learning data group in the learning of one machine learning model, or a collection of second type divided input data can be used as one input learning data group in the learning of one machine learning model. This makes it possible to reduce the amount of data used in the learning of one machine learning model, and thus suppresses the learning from taking a long time.

(2) According to a second aspect of the present disclosure, a determining method for determining a class of data to be determined using M (an integer of two or more) number of vector neural network type machine learning models including a plurality of vector neuron layers is provided. The determining method includes (a) preparing the M number of machine learning models trained using a plurality of pieces of data for learning including data for input and a pre-label associated with the data for input, wherein each one of the M number of machine learning models is trained using one corresponding group of one or more input learning data groups, the one or more input learning data groups being obtained by dividing the plurality of pieces of data for learning; (b) preparing M number of known feature spectrum groups corresponding to the M number of machine learning models after training, wherein the M number of known feature spectrum groups include a known feature spectrum group obtained from an output of a specific layer from among the plurality of vector neuron layers by inputting the input learning data groups into the M number of machine learning models after the training; (c) obtaining individual data used in class determination of the data to be determined for each one of the M number of machine learning models by inputting data to be determined for input generated from the data to be determined into each one of the M number of machine learning models after the training, wherein, for each one of the M number of machine learning models, the individual data is generated using at least one of (i) a similarity between a feature spectrum calculated from an output of the specific layer according to input of the data to be determined for input into the machine learning model and the known feature spectrum group, and (ii) an activation value corresponding to a determination value for each class output from an output layer of the machine learning model according to an input of the data to be determined for input; and (d) executing class determination for the data to be determined using M number of pieces of the individual data obtained respectively for the M number of machine learning models, wherein (a) includes one of (a1) dividing the plurality of pieces of data for input into one or more regions, and using a collection of first type divided input data after division belonging to the same region as one of the input learning data groups, and (a2) executing division processing to divide the plurality of pieces of data for learning belonging to one class into one or more groups, and using a collection of second type divided input data after the division processing as one of the input learning data groups.

According to this aspect, a collection of first type divided input data can be used as one input learning data group in the learning of one machine learning model, or a collection of second type divided input data can be used as one input learning data group in the learning of one machine learning model. This makes it possible to determine a class of the data to be determined using a machine learning model that can reduce the amount of data used in the learning of one machine learning model, and thus suppresses the learning from taking a long time.

(3) In the aspect described above, each one of the M number of pieces of individual data may include the activation value corresponding to each class; and (d) may include setting, as a determination class, a class with a highest activation value for determination calculated using a cumulative activation value obtained by adding together the activation values of the M number of pieces of individual data for each class. According to this aspect, the determination class can be easily determined using the activation value for determination.

(4) In the aspect described above, each one of the M number of pieces of individual data may include the similarity; and (d) may include (d1) generating a similarity for determination by integrating the respective similarities of the machine learning models, and (d2) setting, when the similarity for determination is equal to or greater than a predetermined threshold, a class with a highest activation value for determination as the determination class, and setting, when the similarity for determination is less than the threshold, regardless of the activation value for determination, an unknown class different from a class corresponding to a pre-label, as the determination class. According to this aspect, the determination class can be determined with high accuracy using the similarity for determination and the activation value for determination.

(5) In the aspect described above, (c) may include generating a class corresponding to the activation value with a highest value from among the activation values corresponding to the classes for each machine learning model as a pre-determined class as an element of the individual data. According to this aspect, a class corresponding to the determination class candidate can be generated by setting the class corresponding the activation value with the highest value as the pre-determined class.

(6) In the aspect described above, (c) may include generating, when the similarity is equal to or greater than a predetermined threshold, a class corresponding to the activation value with a highest value from among the activation values corresponding to the classes as a pre-determined class as an element of the individual data for each machine learning model, and generating, when the similarity is less than the threshold, the pre-determined class as an unknown class different from a class corresponding to the pre-label as an element of the individual data for each machine learning model. According to this aspect, since an unknown class can be set as a pre-determined class, class determination of the data to be determined can be executed with higher accuracy.

(7) In the aspect described above, (c) may include (i) for each one of the plurality of specific layers, calculating a multiplication value obtained by multiplying a weighting coefficient set for each one of the plurality of specific layers and the similarity corresponding to one of the specific layers and setting a sum of the multiplication values calculated as the similarity used in class determination, or (ii) setting a maximum value or a minimum value of the similarities corresponding to the plurality of specific layers as the similarity used in class determination. According to this aspect, even when a plurality of specific layers are provided, similarity used for the class determination can be easily calculated.

(8) In the aspect described above, each known feature spectrum included in the known feature spectrum group prepared in (b) is associated with class classification information indicating which class the known feature spectrum belongs to, and when the known feature spectrum associated with the class classification information is referred to as a by class known feature spectrum, (c) may include calculating a by class similarity, which is the similarity between the by class known feature spectrum and the feature spectrum, for each class, and generating the class associated with the by class similarity with a highest value from among the class similarities calculated for the classes as a pre-determined class as an element of the individual data. According to this aspect, the pre-determined class can be easily generated using the by class similarity.

(9) In the aspect described above, the calculating of the by class similarity in (c) may include

calculating the similarity between each one of the plurality of by class known feature spectrums and the feature spectrum for each class, and calculating a representative similarity of the plurality of similarities for each class by executing statistical processing of the plurality of similarities calculated for each class; and the generation in (c) may include generating the class associated with the representative similarity with a highest value from among the representative similarities calculated for each class as the pre-determined class as an element of the individual data. According to this aspect, the pre-determined class can be easily generated using the representative similarity.

(10) In the aspect described above, the statistical processing of the plurality of similarities may include calculating a maximum value, a median value, an average value, or a modal value of the plurality of similarities as the representative similarity. According to this aspect, the pre-determined class can be easily generated using the representative similarity.

(11) In the aspect described above, (c) may further include generating an unknown class different from a class corresponding to the pre-label instead of the class associated with the by class similarity as the pre-determined class as an element of the individual data when the highest value is less than a predetermined threshold. According to this aspect, an unknown class can be generated as the pre-determination class, and thus a pre-determined class can be generated with higher accuracy.

(12) In the aspect described above, (d) may include setting a most prevalent class from the pre-determined classes included in the individual data of the plurality of machine learning models as a class of the data to be determined. According to this aspect, the class of the data to be determined can be easily determined using the pre-determined class.

(13) In the aspect described above, (c) may include generating a similarity between a feature spectrum calculated from an output of the specific layer and the known feature spectrum group as an element of the individual data; and (d) may include (i) setting a class with a highest value for the similarity from among the pre-determined classes included in the individual data of the plurality of machine learning models as a class of the data to be determined, or (ii) calculating a sum or product of the similarities included in the individual data of classes with the same pre-determined class and setting the pre-determined class with a highest calculated value as a class of the data to be determined. According to this aspect, the determination class of the data to be determined can be easily generated using the similarity.

(14) In the aspect described above, (c) may include generating a similarity between a feature spectrum calculated from an output of the specific layer and the known feature spectrum group as an element of the individual data; and (d) may include calculating a reference value for each one of the plurality of machine learning models using the similarity and a weighting coefficient preset for each one of the plurality of machine learning models, and setting a class of the data to be determined using the pre-determined class and the reference value calculated. According to this aspect, the class of the data to be determined can be determined taking into account the weighting coefficient set for each machine learning model.

(15) In the aspect described above, in the reference value calculating step, the reference value may be calculated for each one of the machine learning models by multiplying the similarity and the weighting coefficient; and the class setting step may include (i) setting the pre-determined class with a highest sum of the reference values of the machine learning models with the same pre-determined class as a class of the data to be determined, or (ii) setting the pre-determined class of the machine learning model with a maximum or minimum value for the reference value as a class of the data to be determined. According to this aspect, the class of the data to be determined can be determined taking into account the weighting coefficient set for each machine learning model.

(16) In the aspect described above, (d) may include, when one of the plurality of pre-determined classes corresponding to the plurality of machine learning models indicates an unknown class different from a class corresponding to the pre-label, setting the unknown class as a class of the data to be determined, regardless of classes indicated by other pre-determined classes. According to this aspect, a class of the data to be determined can be set as the unknown class when one of the pre-determined classes indicates an unknown class.

(17) In the aspect described above, the division processing in (a2) may be (i) executed by performing clustering of the plurality of pieces of data for learning belonging to the same class, or (ii) executed by randomly extracting the plurality of pieces of data for learning belonging to the same class via sampling with replacement. According to this aspect, the collection of the second type divided input data can be easily generated by performing clustering of the plurality of pieces of data for learning or by randomly extraction via sampling with replacement.

(18) According to a third aspect of the present disclosure, a learning apparatus for M (an integer of two or more) number of vector neural network type machine learning models including a plurality of vector neuron layers, the M number of machine learning models being used in determining a class of data to be determined is provided. The learning apparatus includes a memory; and a processor configured to execute training of the M number of machine learning models, wherein the processor executes processing to divide a plurality of pieces of data for learning including data for input and a pre-label associated with the data for input into one or more groups to generate the one or more input learning data groups, and processing to train the M number of machine learning models so that a correspondence between the data for input and the pre-label associated with the data for input is reproduced, by inputting the corresponding input learning data groups respectively into the M number of machine learning models; the processing to generate the one or more input learning data groups includes

processing to divide the plurality of pieces of data for input into one or more regions and generate, as one of the input learning data groups, a collection of first type divided input data after division belonging to the same region, or processing to divide the plurality of pieces of data for learning belonging to one class into one or more groups to generate, as one of the input learning data groups, a collection of second type divided input data after division.

According to this aspect, a collection of first type divided input data can be used as one input learning data group in the learning of one machine learning model, or a collection of second type divided input data can be used as one input learning data group in the learning of one machine learning model. This makes it possible to reduce the amount of data used in the learning of one machine learning model, and thus suppresses the learning from taking a long time.

(19) According to a fourth aspect of the present disclosure, a determining apparatus for determining a class of data to be determined using M (an integer of two or more) number of vector neural network type machine learning models including a plurality of vector neuron layers is provided. The determining apparatus includes a memory configured to store the M number of machine learning models trained using a plurality of pieces of data for learning including data for input and a pre-label associated with the data for input, wherein each one of the M number of machine learning models is trained using one corresponding group of one or more input learning data groups, the one or more input learning data groups being obtained by dividing the plurality of pieces of data for learning; and

a processor configured to execute class determination of the data to be determined by inputting the data to be determined into the M number of machine learning models, wherein the processor executes processing to generate M number of known feature spectrum groups corresponding to the M number of machine learning models after training, wherein the M number of known feature spectrum groups include a known feature spectrum group obtained from an output of a specific layer from among the plurality of vector neuron layers by inputting the input learning data groups into the M number of machine learning models after the training; processing to obtain individual data used in class determination of the data to be determined for each one of the M number of machine learning models by inputting data to be determined for input generated from the data to be determined into each one of the M number of machine learning models after the training, wherein, for each one of the M number of machine learning models, the individual data is generated using at least one of (i) a similarity between a feature spectrum calculated from an output of the specific layer according to input of the data to be determined for input into the machine learning model and the known feature spectrum group, and (ii) an activation value corresponding to a determination value for each class output from an output layer of the machine learning model according to an input of the data to be determined for input; and processing to execute class determination for the data to be determined using M number of pieces of the individual data obtained respectively for the M number of machine learning models; and the input learning data group is either

a collection of first type divided input data after division belonging to the same region of one or more regions obtained by dividing the plurality of pieces of data for input, or a collection of second type divided input data after the division processing in which the plurality of pieces of data for learning belonging to one class are divided into one or more groups.

According to this aspect, a collection of first type divided input data can be used as one input learning data group in the learning of one machine learning model, or a collection of second type divided input data can be used as one input learning data group in the learning of one machine learning model. This makes it possible to determine a class of the data to be determined using a machine learning model that can reduce the amount of data used in the learning of one machine learning model, and thus suppresses the learning from taking a long time.

(20) According to a fifth aspect of the present disclosure, a non-transitory computer-readable storage medium storing a computer program configured to cause a processor to execute training of M (an integer of two or more) number of vector neural network type machine learning models including a plurality of vector neuron layers, the M number of machine learning models being used in determining a class of data to be determined is provided. The computer program includes a function (a) of dividing a plurality of pieces of data for learning including data for input and a pre-label associated with the data for input into one or more groups to generate the one or more input learning data groups; and a function (b) of training the M number of machine learning models so that a correspondence between the data for input and the pre-label associated with the data for input is reproduced, by inputting the corresponding input learning data groups respectively into the M number of machine learning models, wherein the function (a) includes

a function of dividing the plurality of pieces of data for input into one or more regions to generate, as one of the input learning data groups, a collection of first type divided input data after division belonging to the same region, or a function of dividing the plurality of pieces of data for learning belonging to one class into one or more groups to generate, as one of the input learning data groups, a collection of second type divided input data after division.

According to this aspect, a collection of first type divided input data can be used as one input learning data group in the learning of one machine learning model, or a collection of second type divided input data can be used as one input learning data group in the learning of one machine learning model. This makes it possible to reduce the amount of data used in the learning of one machine learning model, and thus suppresses the learning from taking a long time.

(21) According to a sixth aspect of the present disclosure, a non-transitory computer-readable storage medium storing a computer program configured to cause a processor to execute determination of a class of data to be determined using M (an integer of two or more) number of vector neural network type machine learning models including a plurality of vector neuron layers is provided. The computer program includes a function (a) of storing the M number of machine learning models trained using a plurality of pieces of data for learning including data for input and a pre-label associated with the data for input, wherein each one of the M number of machine learning models is trained using one corresponding group of one or more input learning data groups, the one or more input learning data groups being obtained by dividing the plurality of pieces of data for learning; a function (b) of generating M number of known feature spectrum groups corresponding to the M number of machine learning models after training, wherein the M number of known feature spectrum groups include a known feature spectrum group obtained from an output of a specific layer from among the plurality of vector neuron layers by inputting the input learning data groups into the M number of machine learning models after the training; a function (c) of obtaining individual data used in class determination of the data to be determined for each one of the M number of machine learning models by inputting data to be determined for input generated from the data to be determined into each one of the M number of machine learning models after the training, wherein, for each one of the M number of machine learning models, the individual data is generated using at least one of (i) a similarity between a feature spectrum calculated from an output of the specific layer according to input of the data to be determined for input into the machine learning model and the known feature spectrum group, and (ii) an activation value corresponding to a determination value for each class output from an output layer of the machine learning model according to an input of the data to be determined for input; and a function (d) of executing class determination for the data to be determined using M number of pieces of the individual data obtained respectively for the M number of machine learning models, wherein the input learning data group is either a collection of first type divided input data after division belonging to the same region of one or more regions obtained by dividing the plurality of pieces of data for input, or a collection of second type divided input data after the division processing in which the plurality of pieces of data for learning belonging to one class are divided into one or more groups.

According to this aspect, a collection of first type divided input data can be used as one input learning data group in the learning of one machine learning model, or a collection of second type divided input data can be used as one input learning data group in the learning of one machine learning model. This makes it possible to determine a class of the data to be determined using a machine learning model that can reduce the amount of data used in the learning of one machine learning model, and thus suppresses the learning from taking a long time.

The present disclosure may be embodied in various forms other than that described above. For example, the present disclosure can be embodied as a non-transitory storage medium storing a computer program.

What is claimed is:

1. A learning method for M number of vector neural network type machine learning models including a plurality of vector neuron layers, the M number of machine learning models being used in determining a class of data to be determined, M being an integer of two or more, the learning method comprising:
(a) preparing a plurality of pieces of data for learning including data for input and a pre-label associated with the data for input;
(b) dividing the plurality of pieces of data for learning into one or more groups to generate one or more input learning data groups; and
(c) training the M number of machine learning models so that a correspondence between the data for input and the pre-label associated with the data for input is reproduced, by inputting the input learning data groups respectively into the M number of machine learning models, wherein
(b) includes
(b1) dividing the plurality of pieces of data for input into one or more regions to generate, as one of the input learning data groups, a collection of first type divided input data after division belonging to the same region, or
(b2) dividing the plurality of pieces of data for learning belonging to one class into one or more groups to generate, as one of the input learning data groups, a collection of second type divided input data after division.

2. A determining method for determining a class of data to be determined using M number of vector neural network type machine learning models including a plurality of vector neuron layers, M being an integer of two or more, the determining method comprising:
(a) preparing the M number of machine learning models trained using a plurality of pieces of data for learning including data for input and a pre-label associated with the data for input, wherein each one of the M number of machine learning models is trained using one corresponding group of one or more input learning data groups, the one or more input learning data groups being obtained by dividing the plurality of pieces of data for learning;
(b) preparing M number of known feature spectrum groups corresponding to the M number of machine learning models after training, wherein the M number of known feature spectrum groups include a known feature spectrum group obtained from an output of a specific layer from among the plurality of vector neuron layers by inputting the input learning data groups into the M number of machine learning models after the training;
(c) obtaining individual data used in class determination of the data to be determined for each one of the M number of machine learning models by inputting data to be determined for input, generated from the data to be determined, into each one of the M number of machine learning models after the training, wherein, for each one of the M number of machine learning models, the individual data is generated using at least one of (i) a similarity between a feature spectrum calculated from an output of the specific layer according to input of the data to be determined for input into the machine learning model and the known feature spectrum group, and (ii) an activation value corresponding to a determination value for each class output from an output layer of the machine learning model according to an input of the data to be determined for input; and
(d) executing class determination for the data to be determined using M number of pieces of the individual data obtained respectively for the M number of machine learning models, wherein
(a) includes one of:
(a1) dividing the plurality of pieces of data for input into one or more regions, and using a collection of first type divided input data after division belonging to the same region as one of the input learning data groups, and
(a2) executing division processing to divide the plurality of pieces of data for learning belonging to one class into one or more groups, and using a collection of second type divided input data after the division processing as one of the input learning data groups.

3. The determining method according to claim 2, wherein
each one of the M number of pieces of individual data includes the activation value corresponding to each class; and
(d) includes setting, as a determination class, a class with a highest activation value for determination calculated using a cumulative activation value obtained by adding together the activation values of the M number of pieces of individual data for each class.

4. The determining method according to claim 3, wherein
each one of the M number of pieces of individual data includes the similarity; and
(d) includes
(d1) generating a similarity for determination by integrating the respective similarities of the machine learning models, and
(d2) setting, when the similarity for determination is equal to or greater than a predetermined threshold, a class with a highest activation value for determination as the determination class, and setting, when the similarity for determination is less than the threshold, regardless of the activation value for determination, an unknown class different from a class corresponding to a pre-label, as the determination class.

5. The determining method according to claim 2, wherein
(c) includes
generating a class corresponding to the activation value with a highest value from among the activation values corresponding to the classes for each machine learning model as a pre-determined class as an element of the individual data.

6. The determining method according to claim 2, wherein
(c) includes
generating, when the similarity is equal to or greater than a predetermined threshold, a class corresponding to the activation value with a highest value from among the activation values corresponding to the classes as a pre-determined class as an element of the individual data, for each machine learning model, and
generating, when the similarity is less than the threshold, the pre-determined class as an unknown class different from a class corresponding to the pre-label as an element of the individual data for each machine learning model.

7. The determining method according to claim 2, wherein
(c) includes, when a plurality of the specific layers are provided, one of:
(i) for each one of the plurality of specific layers, calculating a multiplication value obtained by multiplying a weighting coefficient set for each one of the plurality of specific layers and the similarity corresponding to one of the specific layers and setting a sum of the multiplication values calculated as the similarity used in class determination, and
(ii) setting a maximum value or a minimum value of the similarities corresponding to the plurality of specific layers as the similarity used in class determination.

8. The determining method according to claim 2, wherein
each known feature spectrum included in the known feature spectrum group prepared in (b) is associated with class classification information indicating which class the known feature spectrum belongs to, and
when the known feature spectrum associated with the class classification information is referred to as a by class known feature spectrum,
(c) includes
calculating a by class similarity, which is the similarity between the by class known feature spectrum and the feature spectrum, for each class, and
generating the class associated with the by class similarity with a highest value from among the by class similarities calculated for the classes as a pre-determined class as an element of the individual data.

9. The determining method according to claim 8, wherein
the calculating of the by class similarity in (c) includes
calculating the similarity between each one of the plurality of by class known feature spectrums and the feature spectrum for each class, and
calculating a representative similarity of the plurality of similarities for each class by executing statistical processing of the plurality of similarities calculated for each class; and
the generation in (c) includes
generating the class associated with the representative similarity with a highest value from among the representative similarities calculated for each class as the pre-determined class as an element of the individual data.

10. The determining method according to claim 9, wherein
the statistical processing of the plurality of similarities includes calculating a maximum value, a median value, an average value, or a modal value of the plurality of similarities as the representative similarity.

11. The determining method according to claim 8, wherein
(c) further includes
generating an unknown class different from a class corresponding to the pre-label instead of the class associated with the by class similarity as the pre-determined class as an element of the individual data when the highest value is less than a predetermined threshold.

12. The determining method according to claim 5, wherein
(d) includes
setting a most prevalent class from the pre-determined classes included in the individual data of the plurality of machine learning models as a class of the data to be determined.

13. The determining method according to claim 5, wherein
(c) includes generating a similarity between a feature spectrum calculated from an output of the specific layer and the known feature spectrum group as an element of the individual data; and
(d) includes one of:
(i) setting a class with a highest value for the similarity from among the pre-determined classes included in the individual data of the plurality of machine learning models as a class of the data to be determined, and
(ii) calculating a sum or product of the similarities included in the individual data of classes with the same pre-determined class and setting the pre-determined class with a highest calculated value as a class of the data to be determined.

14. The determining method according to claim 5, wherein
(c) includes
generating a similarity between a feature spectrum calculated from an output of the specific layer and the known feature spectrum group as an element of the individual data; and
(d) includes
calculating a reference value for each one of the plurality of machine learning models using the similarity and a weighting coefficient preset for each one of the plurality of machine learning models, and setting a class of the data to be determined using the pre-determined class and the reference value calculated.

15. The determining method according to claim 14, wherein
in the reference value calculating step, the reference value is calculated for each one of the machine learning models by multiplying the similarity and the weighting coefficient; and
the class setting step includes
(i) setting the pre-determined class with a highest sum of the reference values of the machine learning models with the same pre-determined class as a class of the data to be determined, or
(ii) setting the pre-determined class of the machine learning model with a maximum or minimum value for the reference value as a class of the data to be determined.

16. The determining method according to claim 5, wherein
(d) includes
when one of the plurality of pre-determined classes corresponding to the plurality of machine learning models indicates an unknown class different from a class corresponding to the pre-label, setting the unknown class as a class of the data to be determined, regardless of classes indicated by other pre-determined classes.

17. The determining method according to claim 2, wherein
the division processing in (a2) is
(i) executed by performing clustering of the plurality of pieces of data for learning belonging to the one class, or
(ii) executed by randomly extracting the plurality of pieces of data for learning belonging to the one class via sampling with replacement.

18. A learning apparatus for M number of vector neural network type machine learning models including a plurality of vector neuron layers, the M number of machine learning models being used in determining a class of data to be determined, M being an integer of two or more, the learning apparatus comprising:
a memory; and
a processor configured to execute training of the M number of machine learning models, wherein
the processor executes
processing to divide a plurality of pieces of data for learning including data for input and a pre-label associated with the data for input into one or more groups to generate one or more input learning data groups, and
processing to train the M number of machine learning models so that a correspondence between the data for input and the pre-label associated with the data for input is reproduced, by inputting the corresponding input learning data groups respectively into the M number of machine learning models;
the processing to generate the one or more input learning data groups includes one of:
processing to divide the plurality of pieces of data for input into one or more regions and generate, as one of the input learning data groups, a collection of first type divided input data after division belonging to the same region, and
processing to divide the plurality of pieces of data for learning belonging to one class into one or more groups to generate, as one of the input learning data groups, a collection of second type divided input data after division.

19. A determining apparatus for determining a class of data to be determined using M number of vector neural network type machine learning models including a plurality of vector neuron layers, M being an integer of two or more, the determining apparatus comprising:
a memory configured to store the M number of machine learning models trained using a plurality of pieces of data for learning including data for input and a pre-label associated with the data for input, wherein each one of the M number of machine learning models is trained using one corresponding group of one or more input learning data groups, the one or more input learning data groups being obtained by dividing the plurality of pieces of data for learning; and
a processor configured to execute class determination of the data to be determined by inputting the data to be determined into the M number of machine learning models, wherein
the processor executes
processing to generate M number of known feature spectrum groups corresponding to the M number of machine learning models after training, wherein the M number of known feature spectrum groups include a known feature spectrum group obtained from an output of a specific layer from among the plurality of vector neuron layers by inputting the input learning data groups into the M number of machine learning models after the training;
processing to obtain individual data used in class determination of the data to be determined for each one of the M number of machine learning models by inputting data to be determined for input generated from the data to be determined into each one of the M number of machine learning models after the training, wherein, for each one of the M number of machine learning models, the individual data is generated using at least one of (i) a similarity between a feature spectrum calculated from an output of the specific layer according to input of the data to be determined for input into the machine learning model and the known feature spectrum group, and (ii) an activation value corresponding to a determination value for each class output from an output layer of the machine learning model according to an input of the data to be determined for input; and
processing to execute class determination for the data to be determined using M number of pieces of the individual data obtained respectively for the M number of machine learning models; and
the input learning data group is either
a collection of first type divided input data after division belonging to the same region of one or more regions obtained by dividing the plurality of pieces of data for input, or
a collection of second type divided input data after the division processing in which the plurality of pieces of data for learning belonging to one class are divided into one or more groups.

20. A non-transitory computer-readable storage medium storing a computer program configured to cause a processor to execute training of M number of vector neural network type machine learning models including a plurality of vector neuron layers, the M number of machine learning models being used in determining a class of data to be determined, M being an integer of two or more, the computer program comprising:
a function (a) of dividing a plurality of pieces of data for learning including data for input and a pre-label associated with the data for input into one or more groups to generate one or more input learning data groups; and
a function (b) of training the M number of machine learning models so that a correspondence between the data for input and the pre-label associated with the data for input is reproduced by inputting the corresponding input learning data groups respectively into the M number of machine learning models, wherein
the function (a) includes
a function of dividing the plurality of pieces of data for input into one or more regions to generate, as one of the input learning data groups, a collection of first type divided input data after division belonging to the same region, or
a function of dividing the plurality of pieces of data for learning belonging to one class into one or more groups to generate, as one of the input learning data groups, a collection of second type divided input data after division.

21. A non-transitory computer-readable storage medium storing a computer program configured to cause a processor to execute determination of a class of data to be determined using M number of vector neural network type machine learning models including a plurality of vector neuron layers, M being an integer of two or more, the computer program comprising:
a function (a) of storing the M number of machine learning models trained using a plurality of pieces of data for learning including data for input and a pre-label associated with the data for input, wherein each one of the M number of machine learning models is trained using one corresponding group of one or more input learning data groups, the one or more input learning data groups being obtained by dividing the plurality of pieces of data for learning;
a function (b) of generating M number of known feature spectrum groups corresponding to the M number of machine learning models after training, wherein the M number of known feature spectrum groups include a known feature spectrum group obtained from an output of a specific layer from among the plurality of vector neuron layers by inputting the input learning data groups into the M number of machine learning models after the training;
a function (c) of obtaining individual data used in class determination of the data to be determined for each one of the M number of machine learning models by inputting data to be determined for input generated from the data to be determined into each one of the M number of machine learning models after the training, wherein, for each one of the M number of machine learning models, the individual data is generated using at least one of (i) a similarity between a feature spectrum calculated from an output of the specific layer according to input of the data to be determined for input into the machine learning model and the known feature spectrum group, and (ii) an activation value corresponding to a determination value for each class output from an output layer of the machine learning model according to an input of the data to be determined for input; and
a function (d) of executing class determination for the data to be determined using M number of pieces of the individual data obtained respectively for the M number of machine learning models, wherein
the input learning data group is either
a collection of first type divided input data after division belonging to the same region of one or more regions obtained by dividing the plurality of pieces of data for input, or
a collection of second type divided input data after the division processing in which the plurality of pieces of data for learning belonging to one class are divided into one or more groups.
